(19) United States
(12) Patent Application Publication
(10) Pub. No.: US 2025/0165009 A1
(43) Pub. Date: May 22, 2025

(54) METHOD FOR EXPLORING GROUND MATERIAL, CLEANING ROBOT, AND STORAGE MEDIUM

(71) Applicants: YUNJING INTELLIGENCE (SHENZHEN) CO., LTD., SHENZHEN (CN); YUNJING INTELLIGENCE INNOVATION (SHENZHEN) CO., LTD., SHENZHEN (CN)

(72) Inventor: JINTAO WANG, SHENZHEN (CN)

(21) Appl. No.: 19/031,364

(22) Filed: Jan. 18, 2025

Related U.S. Application Data
(63) Continuation of application No. PCT/CN2023/109642, filed on Jul. 27, 2023.

(30) Foreign Application Priority Data
Jul. 29, 2022 (CN) 202210910938.1

(51) Int. Cl. G05D 1/648; A47L 11/40; G05D 105/10

(52) U.S. Cl. CPC G05D 1/6486; A47L 11/4011; A47L 2201/04; A47L 2201/06; G05D 2105/10

(57) ABSTRACT

The present disclosure relates to the field of cleaning technology and discloses a method for exploring a ground material, a cleaning robot, and a storage medium. The method includes: obtaining status information of the cleaning robot and selecting an edge exploration mode based on the status information when the cleaning robot detects a preset ground material, wherein the edge exploration mode is either an inner edge exploration mode or an outer edge exploration mode; and performing edge exploration on the preset ground material according to the edge exploration mode and obtaining a contour of the preset ground material.

### TECHNICAL FIELD

The present disclosure relates to the field of cleaning technology, and in particular to a method for exploring a ground material, a cleaning robot, and a storage medium.

### BACKGROUND

With the continuous improvement of living standards and science and technology, nowadays, more and more users begin to use robots to allow the robots providing corresponding services for people. Cleaning robots are used to replace people to perform cleaning of the home or large places, which not only reduces the work pressure of people, but also improves the cleaning efficiency.

Cleaning robots in related arts are commonly provided with special sensors to detect the ground, for example, an ultrasound sensor is provided to detect the material of the ground to identify the type of ground. However, the related arts only deal with detecting and confirming the ground material, and does not deal with adjusting the response mode of the cleaning robot when special material is detected, such as a carpet.

### SUMMARY

The primary purpose of the present disclosure is to provide a method for exploring a ground material, a cleaning robot, and a storage medium, aiming at controlling the cleaning robot to explore a preset ground material in response to that the ground material being detected by the cleaning robot is a preset ground material.

In a first aspect, the present disclosure provides a method for exploring a ground material comprising:
obtaining status information of the cleaning robot and selecting an edge exploration mode based on the status information when the cleaning robot detects a preset ground material, wherein the edge exploration mode is either an inner edge exploration mode or an outer edge exploration mode, the inner edge exploration mode means the cleaning robot exploring an edge of the preset ground material on an inner side of the preset ground material, and the outer edge exploration mode means the cleaning robot exploring the edge of the preset ground material on an outer side of the preset ground material; and
performing edge exploration of the preset ground material according to the edge exploration mode and obtaining a contour of the preset ground material.

In a second aspect, the present disclosure further provides a cleaning robot. The cleaning robot comprises a processor, a memory, and computer-executable instructions stored on the memory and executable by the processor, wherein when the computer-executable instructions are executed by the processor, the steps of the method for exploring the ground material as described above is implemented.

In a third aspect, the present disclosure further provides a computer readable storage medium. The computer readable storage medium stores computer-executable instructions, and the computer-executable instructions, when being executed by a processor, cause the processor to implement the steps of the method for exploring the ground material as described above.

The present disclosure provides a method for exploring a ground material, a cleaning robot, and a storage medium. In the present disclosure, when a preset ground material is detected by the cleaning robot, status information of the cleaning robot is obtained and edge exploration mode is determined based on the status information. The edge exploration mode is either an inner edge exploration mode or an outer edge exploration mode. The preset ground material is then explored along the edge based on the determined edge exploration mode to obtain the contour of the preset ground material. By way of the technical solution of the present disclosure, it is realized to control the cleaning robot to explore the preset ground material upon the preset ground material being detected by the cleaning robot.

### BRIEF DESCRIPTION OF DRAWINGS

In order to illustrate the technical solutions of the embodiments of the present disclosure more clearly, the accompanying drawings are briefly described below. The drawings described below are some of the embodiments, and it would be obvious for those skilled in the art to obtain other drawings based on these drawings without any creative efforts.

FIG. 1 is a schematic flow diagram of the steps of a method for exploring a ground material according to an embodiment of the present disclosure;

FIG. 2 is a schematic diagram of a cleaning robot performing an inner edge exploration and performing a first preset action on a preset ground material according to an embodiment of the present disclosure;

FIG. 3 is a schematic diagram of scenes in which the cleaning robot performs inner edge exploration on a preset ground material according to an embodiment of the present disclosure;

FIG. 4 is a structural schematic diagram of the cleaning robot according to an embodiment of the present disclosure;

FIG. 5 is a schematic diagram of scenes in which the cleaning robot performs outer edge exploration on a preset ground material according to an embodiment of the present disclosure;

FIG. 6 is a schematic diagram of a further scene of the cleaning robot performing outer edge exploration on a preset ground material according to an embodiment of the present disclosure;

FIG. 7 is a schematic diagram of a scene in which a cleaning robot determines a contour of a preset ground material by connecting contour points according to an embodiment of the present disclosure;

FIG. 8 is a schematic diagram of a scene of fitting the contour of the preset ground material according to an embodiment of the present disclosure;

FIG. 9 is a schematic diagram of a scene in which a cleaning robot determines the contour of the preset ground material by executing a graphic matching process to contour points, according to an embodiment of the present disclosure;

FIG. 10 is a schematic diagram of a scene in which a cleaning robot merges adjacent material areas according to an embodiment of the present disclosure;

FIG. 11 is a schematic diagram of a trajectory of a cleaning robot sweeping a preset ground material according to an embodiment of the present disclosure;

FIG. 12 is a schematic diagram of a cleaning robot exploring a preset ground material in different trajectories according to an embodiment of the present disclosure;

FIG. 13 is a schematic flow diagram of a method for exploring a ground material according to an embodiment of the present disclosure; and

FIG. 14 is a structural schematic block diagram of the cleaning robot according to an embodiment of the present disclosure.

The realization of the purpose, functional features and advantages of the present disclosure will be further described with reference to the drawings in conjunction with the embodiments.

### DESCRIPTION OF EMBODIMENTS

The technical solutions in the embodiments of the disclosure will be clearly and completely described below with reference to the accompanying drawings in the embodiments of the present disclosure. Obviously, the embodiments described herein are some rather than all of the embodiments of the present disclosure. Based on the embodiments in the present disclosure, all other embodiments obtained by those skill in the art without any creative efforts shall fall within the protection scope of the present disclosure.

The flowcharts shown in the drawings are merely illustrative and do not necessarily include all of the contents and operations/steps, nor do they have to be executed in the order described herewith. For example, some operations/steps may be decomposed, combined, or partially combined, so the actual execution order may be changed in the sense of an actual situation. In addition, although the functional modules are divided in the schematic diagram of the device, in some cases, it is possible to divide the modules in different ways than in the schematic diagram of the device.

Embodiments of the present disclosure provide a method for exploring a ground material, a cleaning robot, and a storage medium. The method is applied to a cleaning robot, which may be a ground sweeper, or other intelligent robots, and the present disclosure is certainly not limited herein.

The present disclosure is described in detail below with reference to the accompanying drawings. In the case of no conflict, the following embodiments and features in the embodiments may be combined with each other.

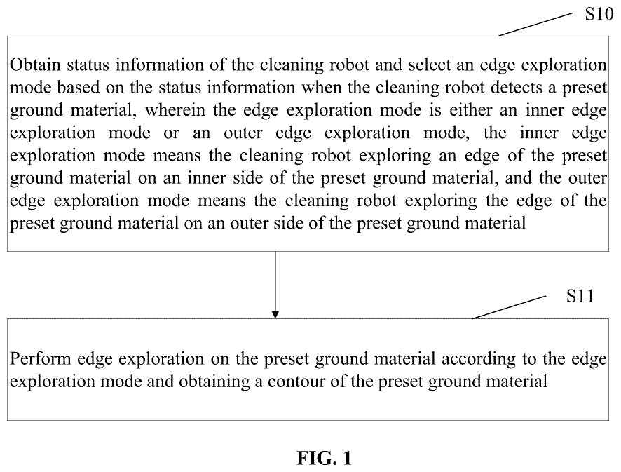

Referring to FIG. 1, FIG. 1 is a schematic flow diagram of a method for exploring a ground material according to an embodiment of the present disclosure.

As shown in FIG. 1, the method for exploring the ground material includes steps S10 to S11.

In step S10, status information of the cleaning robot is obtained and an edge exploration mode is selected based on the status information upon a detecting of a preset ground material by the cleaning robot, wherein the edge exploration mode is either an inner edge exploration mode or an outer edge exploration mode.

In some embodiments, the preset ground material include carpets, foot mats, children's crawl mats, and cool mats laid on the ground, etc., Of course, the preset ground material can also be other material laid on the ground that require special treatment, when being encountered by the cleaning robot, the present disclosure is not limited herein.

In some embodiments, the outer edge exploration mode means the cleaning robot exploring the edge of the preset ground material on the outer side of the preset ground material, and the orthographic projection of the geometric center of the cleaning robot does not fall into the orthographic projection of the preset ground material during the outer edge exploration, so as to control the range of activity of the cleaning robot during the outer edge exploration to reduce the degree of wetting or staining the preset ground material by the mopping member. The inner edge exploration mode means the cleaning robot exploring the edge of the preset ground material on the inner side of the preset ground material, and the trajectory formed by the orthographic projection of the geometric center of the cleaning robot at least partially overlaps with the orthographic projection of the preset ground material during the edge exploration on the inner side.

In some embodiments, in case the cleaning robot is in the outer edge exploration mode, the cleaning robot performs edge exploration on the outer side of the preset ground material, less than 50% of the orthographic projection of the cleaning robot overlaps with the orthographic projection of the preset ground material, thereby reducing the extent to which the mopping member wetting or staining the preset ground material. In case the cleaning robot is in the inner edge exploration mode, the cleaning robot performs edge exploration on the inner side of the preset ground material, and greater than or equal to 50% of the orthographic projection of the cleaning robot overlaps with the orthographic projection of the preset ground material.

In case the cleaning robot encounters a preset ground material while moving or performing a cleaning task without special countermeasures, the cleaning robot or the preset ground material may be damaged. For example, in case the preset ground material is a carpet, the cleaning robot may get stuck by the carpet while moving on the carpet, and in case the cleaning robot is currently performing the mopping task, the cleaning robot may wet the carpet during the mopping.

The cleaning robot can detect whether a preset ground material is encountered by a variety of technical means. The following is an illustration for which the preset ground material is a carpet. In some embodiments, the cleaning robot can detect the carpet by means of an ultrasonic sensor.

When the preset ground material is detected by the cleaning robot during moving, it means that the cleaning robot may have reached or approached an edge of the preset ground material, then the cleaning robot can select the edge exploration mode to explore the preset ground material according to the status information. After determining the position and contour of the preset ground material by way of the edge exploration, the cleaning robot can design a circumventing route or to clean the ground material according to the position and contour of the preset ground material, when the cleaning robot is planning an advancing trajectory or a cleaning trajectory.

In some embodiments, the method further includes:

When the preset ground material is detected by the cleaning robot during moving, at that time in case the cleaning robot is currently constructing a cleaning area map at that time, then edge exploration is not performed on the preset ground material.

It should be understood that the cleaning robot 1 determines travel route and the cleaning trajectory based on the cleaning area map, in case the cleaning robot 1 is newly bought, the cleaning robot needs to explore the surrounding environment first to build an initial cleaning area map before the cleaning robot performing the cleaning task. In order to improve the efficiency of building the map, edge exploration is not performed on the preset ground material in case the preset ground material is detected during the cleaning robot building the map.

In some embodiments, the method further includes:

In case a contour information of the preset ground material has been recorded in the cleaning area map, edge exploration is not performed on the preset ground material when the preset ground material is detected by the cleaning robot during moving.

It should be understood that the edge exploration of the cleaning robot necessarily requires certain time length, therefore, in case the contour information of the current ground material has been recorded in the cleaning area map of the cleaning robot, the cleaning robot does not need to perform edge exploration on the preset ground material again when the preset ground material is detected by the cleaning robot during moving. The cleaning area map is the map for the cleaning robot to design the travel path or the cleaning path.

In some embodiments, the method further includes:
in case the contour information of the preset ground material has been recorded in the cleaning area map, the recording time for recording the contour information is acquired, and the time interval between the recording time and the current time is calculated;
in case the time interval is greater than a preset duration, the cleaning robot is controlled to perform edge exploration on the preset ground material to update the contour information of the preset ground material in the cleaning area map based on the exploration result.

It should be understood that the working environment of the cleaning robot is dynamic, and the cleaning area map can be updated periodically based on the technical solution provided by the present disclosure.

In some embodiments, the obtaining the status information of the cleaning robot and selecting an edge exploration mode based on the status information, including:
obtaining configuration information of the cleaning robot and selecting an edge exploration mode from either one of the inner edge exploration mode and the outer edge exploration mode based on the configuration information; or
obtaining environmental information around the cleaning robot and selecting an edge exploration mode from either one of the inner edge exploration mode and the outer edge exploration mode based on the environmental information.

It should be understood that the status information of the cleaning robot may be either configuration information or environmental information about the surrounding area (e.g., obstacles, cliffs, and other special terrain distribution) acquired by the cleaning robot through sensors (e.g., LIDAR, cliff sensors, vision sensors, etc.).

The environmental information includes environmental structural features and environmental semantic features acquired by the cleaning robot through sensors, as well as environmental information acquired by the cleaning robot during historical cleaning tasks. The environmental structural features may provide information such as the shape and space of the object, and the environmental semantic features may provide information such as the categorization and attributes of the object. The environmental information acquired by the cleaning robot in the historical cleaning task may be characteristic information of the preset ground material perceived by the cleaning robot in conjunction with a behavior of the cleaning robot when the cleaning robot performs cleaning in the area where the preset ground material is located in the historical cleaning task. The environmental information may be obtained by the cleaning robot in the historical cleaning task and updated in the cleaning map, or it may be obtained by the cleaning robot in real time in the current cleaning task and updated in the cleaning map, and the present application does not limit this.

In some embodiments, in case the edge exploration mode is determined by the cleaning robot according to the configuration information, the configuration information may include the operating mode of the cleaning robot and/or the status of the ground material cleaning function.

In some embodiments, when the configuration information includes the working mode of the cleaning robot and the status of the ground material cleaning function, the strategy for the cleaning robot to determine the edge exploration mode is shown in Table 1 below. In case the working mode of the cleaning robot is the “sweeping mode”, the edge exploration mode is determined to be the inner edge exploration mode. When the cleaning robot works in the “sweeping mode”, only the sweeping member works and the mopping member does not work, so that the edge of the preset ground material can be explored using the inner edge exploration mode. In case the working mode of the cleaning robot is the “mopping mode”, the edge exploration mode is determined to be the outer edge exploration mode. When the cleaning robot works in the “mopping mode”, only the mopping member works and the sweeping member does not work, and the preset ground material can not be cleaned by the sweeping member, so that the edge of the preset ground material can be explored using the outer edge exploration mode. In case the working mode of the cleaning robot is the “sweeping and mopping mode”, and the status of ground material cleaning function is “on”, the edge exploration mode is determined to be the inner edge exploration mode. In case the working mode of the cleaning robot is the “sweeping and mopping mode”, and the status of ground material cleaning function is “off”, the edge exploration mode is determined to be the outer edge exploration mode. When the cleaning robot works in the “sweeping and mopping mode”, both sweeping and mopping members can be in the working state. When the status of the ground material cleaning function is “on”, it means that the current cleaning task needs to clean the preset ground material, so the inner edge exploration mode can be used to explore the edge of the preset ground material (i.e., the cleaning robot can go up to the preset ground material and perform edge exploration within the preset ground material). When the status of the ground material cleaning function is “off”, it means that the current cleaning task does not need to clean the preset ground material, and therefore the outer edge exploration mode can be used to explore the edge of the preset ground material. (i.e., the cleaning robot does not need to go up to the preset ground material, but carries outer edge exploration outside the preset ground material).

TABLE I

| | Status of ground | |
|---|---|---|
| | material cleaning | |
| Working mode | function | Edge exploration mode |
| Sweeping mode | | Inner edge exploration mode |
| Mopping mode | | Outer edge exploration |
| | | mode |
| Sweeping and | On | Inner edge exploration mode |
| mopping mode | | |
| Sweeping and | Off | Outer edge exploration |
| mopping mode | | mode |

In some embodiments, in case the cleaning robot determines the edge exploration mode based on the environmental information, the distribution of the obstacles on and/or around the preset ground material is obtained through the environmental information, and the edge exploration mode is determined based on the number and the distribution of obstacles on and/or around the preset ground material, so as to improve the exploration efficiency of the cleaning robot. Exemplarily, in case the number of obstacles on the preset ground material is greater than a preset number, the outer edge exploration mode is selected to explore the preset ground material; and in case the number of obstacles on the preset ground material is less than or equal to the preset number, the inner edge exploration mode is selected to explore the preset ground material; or, in case the position of the obstacle on the preset ground material is close to the edge of the preset ground material which may affect the travel of the cleaning robot, the outer edge exploration mode is selected to explore the preset ground material; in case the position of the obstacle on the preset ground material is far from the edge of the preset ground material which may not affect the travel of the cleaning robot, the inner edge exploration mode is selected to explore the preset ground material. Exemplarily, if at least one edge of the preset ground material is placed against a wall, the inner edge exploration mode is selected to explore the preset ground material.

In some embodiments, when the cleaning robot selects the edge exploration mode by means of environmental information, it may obtain categorization and attributes of obstacles on and/or around the preset ground material by means of the environmental information, and selects the edge exploration mode based on the categorization and attributes of the obstacles on and/or around the preset ground material, so as to improve the exploration efficiency of the cleaning robot. Exemplarily, if there are static obstacles that the cleaning robot needs to avoid (e.g., data cables, charging cables) on the preset ground material, the outer edge exploration mode is selected for exploring the preset ground material; if there are static obstacles that the cleaning robot needs to avoid (e.g., pet feces) in the periphery of the preset ground material, the inner edge exploration mode is selected for exploring the preset ground material; if there are dynamic obstacles on the preset ground material that the cleaning robot does not need to avoid (e.g., pets such as cats and dogs, which are automatically avoided by the cleaning robot when it is close by, and therefore do not need to be avoided by the cleaning robot), the influence of the dynamic obstacles can be disregarded, and the edge exploration mode can be selected based on the other environmental information.

In some embodiments, when the cleaning robot determines the edge exploration mode by means of the environmental information, it may obtain characteristic information of the preset ground material by means of the environmental information, and determine the edge exploration mode based on the characteristic information of the preset ground material, so as to improve the exploration efficiency of the cleaning robot. Exemplarily, if the cleaning robot has ever moved to the preset ground material during a historical cleaning task, and the cleaning robot has difficulty moving on the preset ground material, such as a jamming, slipping, and other behaviors, the preset ground material is currently being explored by selecting the outer edge exploration mode.

Step S11, the edge exploration is performed on the preset ground material according to the edge exploration mode and a contour of the preset ground material is obtained.

It should be understood that once the edge exploration mode is determined, the outer edge exploration or inner edge exploration of the preset ground material can be performed based on the edge exploration mode, and the contour of the preset ground material is determined during the exploration.

In particular, the integrity of the contour of the preset ground material determined by the exploring of the cleaning robot by using the inner edge exploration mode is higher compared to the outer edge exploration mode. For example, in case there are obstacles placed around the preset ground material and the cleaning robot explores the preset ground material using the outer edge exploration mode, the obstacles may hinder the exploring behavior of the cleaning robot and thus complete contour of the preset ground material cannot be obtained.

In addition, in case the edge exploration mode is the outer edge exploration mode, the cleaning robot may reduce the extent to which the mopping member wetting or staining the preset ground material area during the outer edge exploration. For example, in case the cleaning robot is in the mopping mode, and the cleaning robot adopts the inner edge exploration mode when the preset ground material is detected, the cleaning robot may wet or even stain the preset ground material on a large scale.

In some embodiments, the contour refers to the boundary of a preset ground material obtained by fitting the contour points of the edge of the preset ground material, or a boundary obtained by expanding a preset dimension outwardly based on the boundary obtained by fitting the contour points of the edge of the preset ground material. It should be understood that there will be a certain degree of lag in the detection results of the sensors of the cleaning robot, so the boundary obtained by expanding a preset dimension outwardly based on the boundary obtained by fitting the detected contour points will be more accurate and consistent with the actual situation.

It should be understood that the contour of the preset ground material can be determined according to the contour points of the edge of the preset ground material, after the contour of the preset ground material is updated to the cleaning area map of the cleaning robot, the cleaning robot can subsequently design a circumventing path or a cleaning path for the preset ground material according to the contour of the preset ground material when the cleaning robot designs a path according to the cleaning area map.

In some embodiments, wherein in case the inner edge exploration mode is selected as the edge exploration mode, the performing edge exploration on the preset ground material according to the edge exploration mode and obtaining the contour of the preset ground material, includes: in response to the preset ground material being detected by the cleaning robot, controlling the cleaning robot to perform an inner edge exploration task to obtain contour points of the preset ground material until the cleaning robot reaches a first contour point position again, wherein the first contour point position is a position where the cleaning robot obtains a first one of the contour points. It is determined that the cleaning robot reaches the first contour point position again when the coordinate of the cleaning robot coincides with or is in a preset distance from the coordinate of the cleaning robot obtaining the first contour point. In some embodiments, the coordinate of the cleaning robot may be determined by the coordinate of the sensor that detects the ground material.

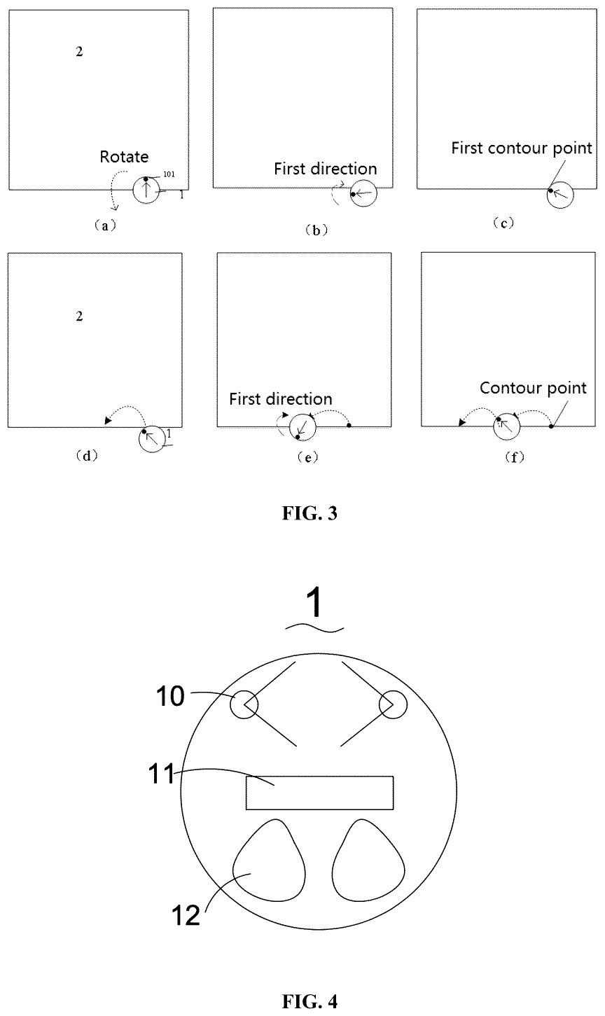

Referring to FIG. 3, FIG. 3 is a schematic diagram of a scene in which the cleaning robot performs the inner edge exploration on a preset ground material according to an embodiment of the present disclosure.

As shown in FIG. 3, in the process of the cleaning robot 1 entering the preset ground material area 2 from the non-preset ground material area, the cleaning robot is controlled to perform an inner edge exploration task when the preset ground material is detected by the cleaning robot, to acquire contour points of the preset ground material until the cleaning robot reaches the first contour point position again, and the first contour point position is the position where the cleaning robot obtains the first one of the contour points. It should be understood that in case the cleaning robot reaches the first contour point position again, it means that the cleaning robot has returned to the position where the first contour point was detected and the exploration path for the preset ground material has formed a closed loop, i.e., the cleaning robot has completed the exploration to the preset ground material. It should be understood that the cleaning robot reaching the first contour point position again is not limited to that the cleaning robot must return to the position overlapping with the first contour point, in case the distance between the cleaning robot and the first contour point is less than a preset distance threshold, it can also be determined that the cleaning robot reaches the first contour point again.

In some embodiments, the controlling the cleaning robot to perform the inner edge exploration task to obtain contour points of the preset ground material, includes: controlling the cleaning robot to perform a first preset action until the cleaning robot detects a non-preset ground material; controlling the cleaning robot to rotate in a first direction, and when the cleaning robot detects the preset ground material again, obtaining a current coordinate of the cleaning robot and marking the current coordinate as one of the contour points; controlling the cleaning robot to advance at a preset angular velocity and a preset linear velocity, and when the cleaning robot detects the non-preset ground material again, repeating the step of controlling the cleaning robot to rotate in the first direction to obtain the contour points.

As shown in FIG. 3(a), in case the edge exploration mode is an inner edge exploration mode and the cleaning robot 1 has been located in the area corresponding to a preset ground material 2, it is necessary to confirm that the cleaning robot 1 is currently located near the edge of the preset ground material, so that the following behaviors of the cleaning robot 1 can be determined as a valid edge exploration behavior. In case the coordinate of the cleaning robot, at the time the preset ground material being detected by the cleaning robot, is close to the edge of the preset ground material, only if the cleaning robot 1 is close to the edge of the preset ground material, the coordinate of the cleaning robot at the time the preset ground material being detected by the cleaning robot can be determined as the contour point of the preset ground material. Exemplarily, the cleaning robot may be controlled to perform the first preset action until the cleaning robot detects the non-preset ground material, at that time the current position of the cleaning robot can be determined to be close to the edge of the preset ground material, to ensure that the point detected during the following exploration behaviors of the cleaning robot is a contour point. As shown in FIG. 3(b), when the position of the current cleaning robot is determined to be close to the edge of the preset ground material, the cleaning robot is controlled to rotate in the first direction. As shown in FIG. 3(c), when the preset ground material is detected by the cleaning robot again, it can be determined that the current coordinate of the cleaning robot can be marked as the first contour point. As shown in FIG. 3(d), the cleaning robot is then controlled to travel at a preset angular velocity and a preset linear velocity to make the cleaning robot follow an arcuate path away from first, and then close to, the edge of the preset ground material. When the cleaning robot detects the non-preset ground material again, it indicates that the cleaning robot is close to the edge of the preset ground material again, and so on. Repeating the step of controlling the cleaning robot to rotate along the first direction (i.e., FIG. 3(d)-FIG. 3(f)) to determine the cleaning robot is on the preset ground material and near the edge of the preset ground material (i.e., the position of the sensor of the cleaning robot to detect the preset ground material is located directly above the preset ground material and near the edge of the preset ground material), for continuing to control the cleaning robot to travel at a preset angular velocity and a preset linear velocity, and so on, to obtain other contour points. The edge exploration mode is the inner edge exploration mode, and the cleaning robot can choose the direction of edge exploration, specifically, left edge exploration or right edge exploration. The left edge exploration refers to that the left side of the cleaning robot is close to the edge of the preset ground material to perform the inner edge exploration task, with reference to the direction of travel of the cleaning robot. In case the exploration is the left edge exploration, the first direction is clockwise with reference to the cleaning robot. In case the exploration is the right edge exploration, the first direction is counterclockwise with reference to the cleaning robot. In some embodiments, after controlling the cleaning robot to rotate in the first direction to determine that the cleaning robot is on the preset ground material and close to the edge of the preset ground material, the cleaning robot can also be controlled to travel at a preset angular velocity and a preset linear velocity, with the angular velocity gradually decreasing, as long as it is possible to make the cleaning robot explore in the direction close to the preset ground material. The present disclosure is not limited herein.

It should be understood that the controlling the cleaning robot to travel at a preset angular velocity and a preset linear velocity, with the angular velocity gradually decreasing, allows the range explored by the cleaning robot to be gradually expanded in a spiral with the cleaning robot as the center, and ensures that the cleaning robot is capable of exploring the non-preset ground material, i.e., ensures that the cleaning robot is capable of approaching the inner edge of the preset ground material again, so as to smoothly proceed to the next exploration action to continue the exploration to the preset ground material.

In some embodiments, the controlling the cleaning robot to perform the first preset action until the cleaning robot detects a non-preset ground material, includes: controlling the cleaning robot to rotate, obtaining in real time a rotation angle of the cleaning robot and a detection result of the cleaning robot to a ground material, determining that the detection result of the cleaning robot to the ground material is that the non-preset ground material is detected and the rotation angle of the cleaning robot acquired is smaller than 180°, controlling the cleaning robot to stop rotating; determining that the rotation angle of the cleaning robot reaches 180° and the non-preset ground material is not detected by the cleaning robot, controlling the cleaning robot to stop rotating and controlling the cleaning robot to advance straight along a current direction until the cleaning robot detects the non-preset ground material.

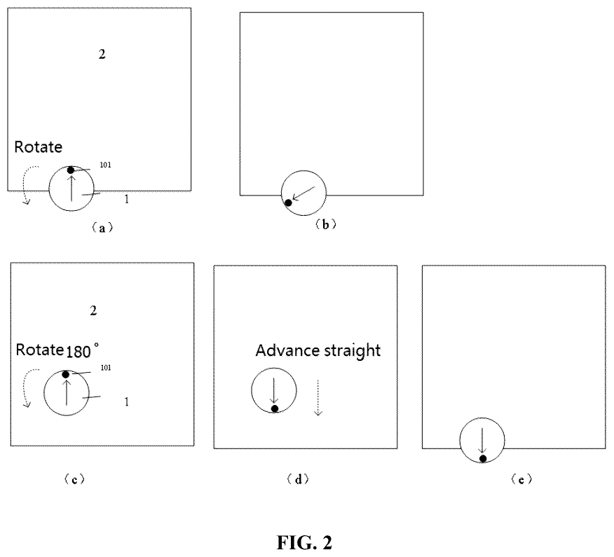

Exemplarily, because there is a certain lag in the sensor detection results, when the cleaning robot detects the preset ground material, most parts of the cleaning robot may be already located on the preset ground material. In case the edge exploration mode is the inner edge exploration mode, in order to make the cleaning robot travel to the edge of the preset ground material faster, the cleaning robot may be controlled to rotate and quickly determine whether the current position of the cleaning robot is close to the edge of the preset ground material. As shown in FIG. 2(a)-(b), when the non-preset ground material is detected by the cleaning robot and the rotation angle is smaller than 180°, it can be determined that the current position of the cleaning robot is close to the edge of the preset ground material, and at that time, the cleaning robot can be controlled to stop the rotation. As shown in FIG. 2(c)-(e), if the non-preset ground material is still not detected by the cleaning robot when the rotation angle reaches 180°, it can be determined that the current cleaning robot has been located on the preset ground material, at that time, the cleaning robot can be controlled to stop rotating and advance straightly along the current direction until the cleaning robot detects the non-preset ground material, and at this time it can be determined that the current position of the cleaning robot is close to the edge of the preset ground material, and the cleaning robot can be controlled to stop advancing, to perform the following inner edge exploration behaviors.

It should be understood that, as shown in FIG. 2, in case the cleaning robot 1 is performing the exploration task, in case the current edge exploration mode is determined to be the inner edge exploration mode, after the preset ground material is detected, the cleaning robot can be controlled to rotate to quickly determine whether the current position of the cleaning robot is close to the edge of the preset ground material. During the rotation of the cleaning robot, when the non-preset ground material is detected by the cleaning robot and the rotation angle is smaller than 180°, it can be determined that the current position of the cleaning robot is close to the edge of the preset ground material, at that time, the cleaning robot can be controlled to stop rotating. In case the non-preset ground material is still not detected and the rotation angle of the cleaning robot reaches 180°, it can be determined that the current cleaning robot has been located on the preset ground material, at that time, the cleaning robot may be controlled to stop rotating and advance straightly along the current direction until the cleaning robot detects the non-preset ground material, and at this time it can be determined that the current position of the cleaning robot is close to the edge of the preset ground material, and the cleaning robot can be controlled to stop travelling. After determining that the current position of the cleaning robot is close to the edge of the preset ground material, the cleaning robot 1 is controlled to rotate in the first direction until the cleaning robot detects the preset ground material, and the current coordinate of the cleaning robot is obtained and marked as the first contour point; then the cleaning robot is controlled to travel at a preset angular velocity and a preset linear velocity, so that the cleaning robot gradually approaches the edge of the preset ground material along an arcuate path, and when a non-preset ground material is detected by the cleaning robot again, it indicates that the cleaning robot approaches the edge of the preset ground material again, and so on, The step of controlling the cleaning robot to rotate along the first direction is repeated to determine the cleaning robot is on the preset ground material and located close to the edge of the preset ground material (i.e., the sensor of the cleaning robot for detecting the preset ground material is located directly above the preset ground material and located close to the edge of the preset ground material), so as to continue controlling the cleaning robot to travel at a preset angular velocity and a preset linear velocity, and so on, to obtain other contour points until the cleaning robot returns to the position of the first contour point again.

In some embodiments, the preset angular velocity may be controlled to gradually decrease. It should be understood that when the cleaning robot travels at a preset angular velocity and a preset linear velocity, with the angular velocity gradually decreasing, the preset trajectory for detecting the preset ground material detected may be a spiral trajectory, which makes the range explored by the cleaning robot be gradually expanded in a spiral with the cleaning robot as the center, which ensures that the cleaning robot can explore the preset ground material signal. In case the angular velocity is constant, the preset trajectory is a circular arc trajectory. Other trajectories may be designed according to the actual needs, which is not limited herein.

In some embodiments, the direction of the preset angular velocity is determined by the first direction. In case the first direction is clockwise with the cleaning robot as a reference, the preset angular velocity is in a direction perpendicular to the ground and outward; in case the first direction is counterclockwise with the cleaning robot as a reference, the preset angular velocity is in a direction perpendicular to the ground and inward.

In some embodiments, the cleaning robot is provided with at least one of a brushing member and a mopping member, wherein the brushing member includes a side brushing member and/or a middle brushing member.

Before controlling the cleaning robot to enter the area corresponding to the preset ground material, the method further includes:
controlling the side brushing member to be in a retracted state in case the cleaning robot is provided with the side brushing member;
controlling the middle brushing member to be in an off-ground state in case the cleaning robot is provided with the middle brushing member;
controlling the mopping member to be in an off-ground state in case the cleaning robot is provided with the mopping member.

Referring to FIG. 4, FIG. 4 is a structural schematic diagram of the cleaning robot according to an embodiment of the present disclosure.

As shown in FIG. 4, the cleaning robot 1 is provided with a brushing member and a mopping member 12, wherein the brushing member includes a side brushing member 10 and a middle brushing member 11, the side brushing member 10 is configured to sweep the garbage in the front side of the coverage area of the cleaning robot, the middle brushing member 11 is configured to sweep the garbage in the middle area of the coverage area of the cleaning robot, and the mopping member 12 is configured to mop the coverage area of the cleaning robot.

In case the preset ground material is a carpet and the cleaning robot 1 needs to enter the carpet to perform inner edge exploration, before the cleaning robot 1 enters the area corresponding to the preset ground material, the side brushing member 10 is controlled to be in the retracted state and the middle brushing member 11 to be in the off-ground state, which can prevent the side brushing member 10 and the middle brushing member 11 from being obstructed by the carpet in the process of entering the area 2. In addition, the cleaning robot 1 controls the mopping member 12 to be in the off-ground state, so as to prevent the mopping member 12 from wetting the carpet after the cleaning robot 1 entering the area 2.

In some embodiments, the cleaning robot is further provided with a fan, and the fan is configured to suck garbage. Before controlling the cleaning robot to enter the area corresponding to the preset ground material, the method further includes:
controlling the cleaning robot to stop moving for a preset length of time, and increasing the fan velocity of the fan;
reducing the fan velocity of the fan after a preset length of time, and controlling the cleaning robot to enter the area corresponding to the preset ground material.

The inventors of the present disclosure found that when the cleaning robot 1 controls the middle brushing member 11 and the mopping member 12 to be in off-ground state, the garbage adhered to the middle brushing member 11 or the mopping member 12 may fall to the ground. At that time, the cleaning robot is controlled to stay in place for a preset length of time and the fan velocity of the fan is increased, so that the fan can suction the garbage falling from the middle brushing member 11 or the mopping member 12 to avoid a secondary pollution. After the preset length of time, the fan velocity of the fan can be reduced and the cleaning robot can be controlled to enter the area 2.

In some implementations, the preset length of time can be set to 5 seconds, 10 seconds, or 15 seconds, but of course, the preset length of time can also be set to other duration as required, which is not limited here.

In some embodiments, after controlling the cleaning robot entering the area corresponding to the preset ground material, the method further includes: controlling the middle brushing member to enter a ground-attached working state and increasing the fan velocity of the fan.

As such, after the cleaning robot 1 enters the area 2, the middle brushing member 11 is controlled to enter the ground-attached working state, then the middle brushing member 11 can sweep the preset ground material during the movement of the cleaning robot 1; and increasing the fan velocity of the fan allows the cleaning robot 1 to sweep the preset ground material more cleanly.

In some embodiments, the cleaning robot is further provided with a drive member for driving the cleaning robot. After controlling the cleaning robot to enter the area corresponding to the preset ground material, the method further includes:
recording the number of times of slipping of the drive member and recording the number of times of jamming of the drive member;
in case the number of times of slipping is greater than a first preset number of times, or in case the number of times of jamming is greater than a second preset number of times, the cleaning robot is controlled to prompt a warning alert.

The drive member is configured to drive the cleaning robot 1 to move forward, steering, or go backward. After entering the area 2, the cleaning robot 1 starts to monitor whether the drive member slips and jams, and records the number of times the drive member slipping as the number of times of slipping, and records the number of times the drive member jamming as the number of times of jamming.

It should be understood that in case the drive member jams within the area 2, the cleaning robot 1 may be damaged; and in case the drive member slips within the area 2, the cleaning robot 1 can hardly to move. Therefore, in case the number of times of slipping is greater than the first preset number of times, or in case the number of times of jamming is greater than the second preset number of times, a warning alert is prompted to allow users who perceives the warning alert to help the cleaning robot 1 out of predicament, so as to avoid the damaging of the cleaning robot 1.

In some embodiments, the first preset number of times may be set to 2, 3 or 5 times, and the second preset number of times may be set to 2, 3 or 5 times. Of course, the first preset number of times and the second preset number of times can also be set to other times according to the actual needs, which is not limited herein.

In some embodiments, after controlling the cleaning robot to enter the area corresponding to the preset ground material, the method further includes:
monitoring whether the side brushing member triggers a current threshold protection in case the cleaning robot is provided with the side brushing member, and recording the number of times of jamming of the middle brushing member;
controlling the side brushing member to be in a free state in case it is monitored that the side brushing member triggers the current threshold protection;
in case the number of times of jamming of the middle brushing member is greater than a third preset number of times, controlling the cleaning robot to prompt warning alert.

After entering the area 2, the cleaning robot 1 starts to monitor whether the side brushing member triggers the current threshold protection, and detects whether jamming of the middle brushing member occurs. In case jamming of the middle brushing member occurs, the jamming times of the middle brushing member is recorded as the number of times of jamming of middle brushing member.

It should be understood that after controlling the cleaning robot 1 into the area 2, in case the side brushing member 10 is found to have triggered the current threshold protection, it indicates that the preset ground material has a large resistance to the side brushing member 10, at that time, the side brushing member 10 is controlled to be in the free state, and the cleaning robot 1 no longer continues to control the side brushing member 10 to sweep, but instead allows the ground material to drive the side brushing member 10 in a free motion. Through the technical solution provided by this embodiment, the side brushing member 10 can be prevent from damaging caused by a too large ground material resistance during the subsequent movement of the cleaning robot 1 in the area 2.

In addition, in case jamming of the middle brushing member 11 occurs within the area 2, the cleaning robot 1 may be damaged. Therefore, in case the cleaning robot 1 finds that the number of times of jamming of middle brushing member is greater than the third preset number of times, a warning alert is prompted to allow users who perceives the warning alert to help the cleaning robot 1 out of predicament, so as to avoid the damaging of the cleaning robot 1.

In some embodiments, the third preset number of times may be set to 2, 3 or 5 times. The third preset number of times can be set to other times as the actual requires, which is not limited herein.

In some embodiments, the cleaning robot 1 may prompt alerts by sound, vibration, light, message push via a terminal smart device such as a cell phone, or other ways as required, which is not limited herein.

In some embodiments, performing edge exploration on the preset ground material according to the edge exploration mode and obtaining a contour of the preset ground material, includes: marking a current position of the cleaning robot as a first contour point position when the cleaning robot detects the preset ground material for a first time; controlling the cleaning robot to perform an outer edge exploration task to obtain contour points of the preset ground material until the cleaning robot reaches the first contour point position again. It should be understood that in case the cleaning robot reaches the first contour point position again, it indicates that the cleaning robot has returned to the position where the first contour point was detected and the exploration path of the preset ground material has formed a closed loop, i.e., the cleaning robot has completed the exploration of the preset ground material. It should be understood that the cleaning robot reaches the first contour point position again is not limited to that the cleaning robot must return to the position overlapping with the first contour point, in case the distance between the cleaning robot and the first contour point is less than the preset distance threshold, it can also be determined that the cleaning robot reaches the first contour point position again.

In some embodiments, the controlling the cleaning robot to perform the outer edge exploration task to obtain contour points of the preset ground material, includes: controlling the cleaning robot to perform a second preset action, wherein the cleaning robot detects a non-preset ground material when the cleaning robot completes the second preset action; controlling the cleaning robot to advance at a preset angular velocity and preset linear velocity, and in case the preset ground material is detected by the cleaning robot again, obtaining the current coordinate of the cleaning robot and marking the current coordinate as one of the contour points; and repeating the step of controlling the cleaning robot to perform the second preset action to continue obtaining the contour points.

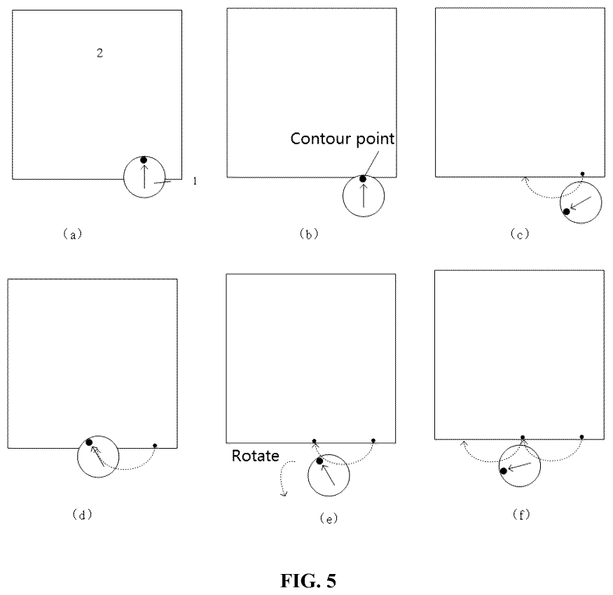

Exemplarily, as shown in FIG. 5, the cleaning robot edge exploration mode is an outer edge exploration mode, as shown in FIG. 5(a)-(b), when the cleaning robot 1 first detects the preset ground material, the current position of the cleaning robot 1 is recorded as a first contour point, and then, the cleaning robot is controlled to perform a second preset action to ensure that the cleaning robot is located outside the preset ground material and that the current position of the cleaning robot is close to an edge of the preset ground material, such that the next behavior of the cleaning robot 1 is a valid edge exploration behavior, and that the points detected during the next exploration behavior performed by the cleaning robot can be determined as contour points. After determining that the cleaning robot is currently located outside the preset ground material and is located close to an edge of the preset ground material, the cleaning robot is controlled to advance at a preset angular velocity and a preset linear velocity, so that the cleaning robot gradually approaches the edge of the preset ground material according to a curved path. When the preset ground material is detected by the cleaning robot again, it indicates that the cleaning robot detects the contour point again, and so on, and the step of controlling the cleaning robot to perform the second preset action is repeated to determine that the cleaning robot is located outside the preset ground material and is located close to the edge of the preset ground material (i.e., the sensor of the cleaning robot for detecting the preset ground material is located outside the preset ground material and close to the edge of the preset ground material), thereby continuing to control the cleaning robot to advance at a preset angular velocity and a preset linear velocity, and so on, to continue to acquire other contour points. In some embodiments, after determining that the cleaning robot is currently located outside the preset ground material and at a location close to the edge of the preset ground material, the cleaning robot may also be controlled to advance at a preset angular velocity and a preset linear velocity, with the angular velocity gradually decreasing as long as it enables the cleaning robot to explore in a direction towards the preset ground material, which is not limited herein. It should be understood that controlling the cleaning robot to advance at a preset angular velocity and a preset linear velocity and gradually decreasing the angular velocity can make the range for which the cleaning robot explore gradually expands in a spiral shape with the cleaning robot as a center, which can ensure that the preset ground material can be explored by the cleaning robot, namely, ensure that the cleaning robot can detect the contour point of the preset ground material again, so as to successfully proceed the next exploration to continue exploring the preset ground material.

In some embodiments, the second preset action is to control the cleaning robot to retreat until the cleaning robot detects the non-preset ground material, and then continue to retreat a preset distance; or to control the cleaning robot to rotate in a preset direction until the cleaning robot detects the non-preset ground material; or to control the cleaning robot to retreat until the cleaning robot detects the non-preset ground material, and continue to retreat a preset distance, and then control the cleaning robot to rotate a preset angle in a preset direction.

Exemplarily, when the outer edge exploration mode is selected as the edge exploration mode, the cleaning robot can select the direction for the edge exploration, for example, left-edge exploration or right-edge exploration. The left-edge exploration means that the left side of the cleaning robot is close to the edge of the preset ground material for the outer edge exploration task with reference to the advance direction of the cleaning robot, and in case the exploration is the left-edge exploration, the direction of rotation of the preset angle in the second preset action is clockwise, the changing trend of the linear velocity direction of the cleaning robot is to change in the counterclockwise direction (i.e., the extension direction of the curved-shaped trajectory of the cleaning robot is counterclockwise), and the angular velocity direction is vertical to the cleaning surface (i.e., the ground surface) and outward. As shown in FIGS. 5(d)-(f), in case the exploration is the right-edge exploration, the direction of the rotation of the preset angle in the second preset action is counterclockwise, and the changing tendency of the linear velocity direction of the cleaning robot is along the clockwise direction (i.e., the extension direction of the curve-shaped trajectory of the cleaning robot is clockwise), and the direction of the angular velocity is vertical to the robot plane and outward.

Referring to FIG. 5, FIG. 5 is a schematic diagram of a scene in which a cleaning robot performs an outer edge exploration to a preset ground material according to an embodiment of the present disclosure.

As shown in FIG. 5(a)-(b), when the cleaning robot 1 detects the preset ground material 2 for the first time and records the current position of the cleaning robot 1 as the first contour point. In case there is no obstacle on the edge of the area 2 of the preset ground material, the cleaning robot 1 is capable of returning to the first contour point while moving around the edge of the area 2, and the exploration task is completed.

After exploring the first contour point, the cleaning robot 1 may have part of the body entering into the area 2, the cleaning robot 1 is controlled to execute the second preset action. In case the cleaning robot 1 completes the second preset action, the cleaning robot is located outside the area 2 of the preset ground material, i.e., the cleaning robot 1 detects the non-preset ground material. Then the cleaning robot 1 is controlled to advance with the preset angular velocity and preset line velocity, and in case the cleaning robot 1 detects the preset ground material again, the current coordinate of the cleaning robot 1 is obtained as the contour point, the second preset action is repeated, and the cleaning robot 1 is controlled to advance at the preset angular velocity and the preset line velocity (the steps in FIG. 5(d)-(f) are repeated) to find the next contour point of the preset ground material. In case the cleaning robot 1 reaches the first contour point again, or in case the distance between the cleaning robot and the first contour point is less than a preset distance threshold, the exploration task is completed. In the exemplary embodiment, when executing the outer edge exploration mode, the second preset action may be to control the cleaning robot 1 to retreat until the cleaning robot detects a non-preset ground material, and to continue to retreat a preset distance; the second preset action may also be to control the cleaning robot 1 to rotate in a preset direction until the cleaning robot 1 detects the non-preset ground material; as shown in FIG. 5(d)-(e), the second preset action may also be to control the cleaning robot 1 to retreat until the cleaning robot 1 detects the non-preset ground material, to continue to retreat a preset distance and then to control the cleaning robot 1 to rotate a preset angle in a preset direction. By controlling the cleaning robot to retreat a preset distance, it can ensure that the mopping member of the cleaning robot is on the outer side of the cleaning robot during the cleaning robot advancing at a preset angular velocity and a preset linear velocity, that is, it prevents the mopping member of the cleaning robot from wetting or contaminating the preset ground material when entering the material area during the cleaning robot advancing at a preset angular velocity and a preset linear velocity. Specifically, take a circular cleaning robot as an example, the preset distance of retreating is related to the longest distance that the orthogonal projection of the mopping member's rotational coverage extends beyond the edge of the cleaning robot. And the rotation of the cleaning robot at a preset angle in a preset direction can extend the trajectory of the cleaning robot advancing at a preset angular velocity and a preset linear velocity, that is, the density of contour points explored by the cleaning robot can be reduced, which can improve the efficiency of the outer edge exploration and shorten the time for the cleaning robot 1 to complete the outer edge exploration. In some embodiments, after determining that the cleaning robot is currently located outside of the preset ground material and at a position close to an edge of the preset ground material, the cleaning robot can also be controlled to advance at a preset angular velocity and a preset linear velocity, with the angular velocity gradually decreasing.

It should be understood that the controlling the cleaning robot to advance at a preset angular velocity and a preset linear velocity, with the angular velocity gradually decreasing, can make the range explored by the cleaning robot be gradually expanded in a spiral shape with the cleaning robot as a center, and can ensure that the non-preset ground material can be explored by the cleaning robot, i.e., ensure that the cleaning robot can approach the inner edge of the preset ground material again, so as to smoothly proceed the next exploration action to continue exploring the preset ground material.

It should be understood that in the outer edge exploration mode, the cleaning robot advances at a preset angular velocity and a preset linear velocity, and the trajectory formed by detecting the preset ground material may be a spiral trajectory, a circular arc trajectory, or other trajectories such as a zigzag trajectory as required, which is not limited herein.

In some embodiments, in case the outer edge exploration mode is selected as the edge exploration mode, the performing edge exploration on the preset ground material according to the edge exploration mode and obtaining the contour of the preset ground material, includes: marking a current position of the cleaning robot as a first contour point position when the cleaning robot detects the preset ground material for a first time; controlling the cleaning robot to perform an outer edge exploration task in a second direction to obtain contour points of the preset ground material; controlling the cleaning robot to perform a third preset action when the cleaning robot detects an obstacle and controlling the cleaning robot to perform the outer edge exploration task in a third direction to obtain contour points of the preset ground material, wherein the third direction is opposite to the second direction; and ending the outer edge exploration task when the cleaning robot detects the obstacle again.

It should be understood that when the preset ground material is detected by the cleaning robot first time, the current position of the cleaning robot is marked as the first contour point position, either one of the left-edge exploration or right-edge exploration is selected to perform the outer edge exploration task. In response to that the cleaning robot detects an obstacle by LIDAR or collision sensor, the cleaning robot is controlled to perform a third preset action and perform the outer edge exploration task in a third direction opposite to the second direction. The process of obtaining the contour points is the same as the aforementioned outer edge exploration task and will not be repeated here. When the cleaning robot detects the obstacle again, the outer edge exploration task is ended. It can be seen that when the cleaning robot is obstructed by an obstacle when performing the outer edge exploration task, the cleaning robot can be controlled to return to the position where the first contour point is obtained and continue to perform the outer edge exploration task in the opposite direction, so that the cleaning robot can maximize the edge exploration of the preset ground material.

In some embodiments, the third preset action is to turn around in place; or to navigate to the first contour point. It should be understood that the cleaning robot may turn around in place and continue the outer edge exploration task in a third direction opposite to the second direction, or navigate to the first contour point and then continue the outer edge exploration task in the third direction opposite to the second direction. It should be understood that turning around in place to continue the outer edge exploration task directly will repeat the exploration of a portion of the preset ground material that has already been explored, so it is more efficient for the cleaning robot to navigate to the first contour point and then continue the outer edge exploration task than to turn around in place to continue the outer edge exploration task directly.

In some embodiments, the preset angular velocity gradually decreases. It is understood that the cleaning robot advances at a preset angular velocity and a preset linear velocity, with the angular velocity gradually decreasing, and the preset trajectory for detecting the preset ground material can be a spiral trajectory, which can make the range explored by the cleaning robot be gradually expanded in a spiral shape with the cleaning robot as a center, which can ensure that the preset ground material can be explored by the cleaning robot. In case the angular velocity is constant, and the preset trajectory is a circular arc trajectory, and other trajectories can also be designed according to actual needs, which is not limited herein.

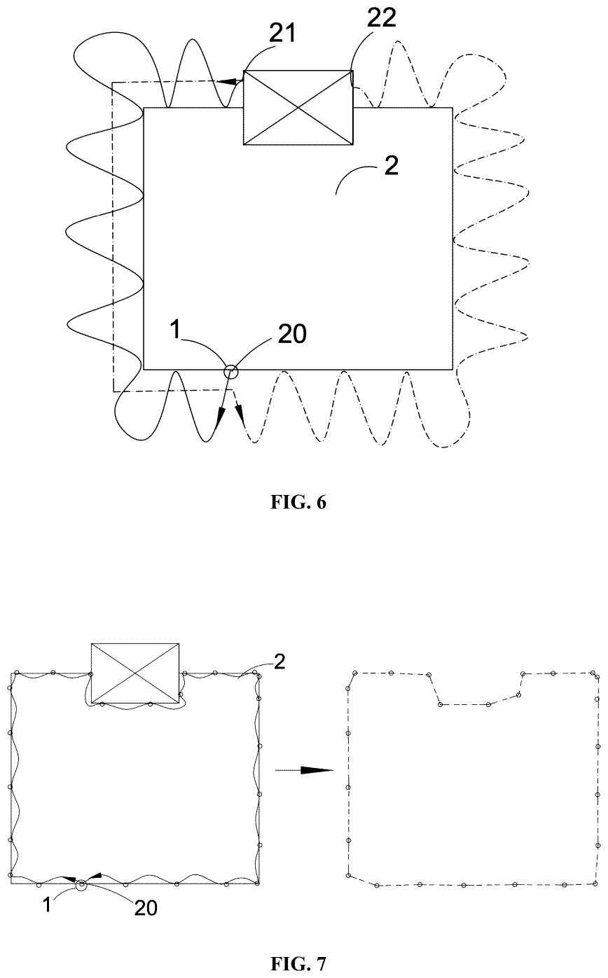

Referring to FIG. 6, FIG. 6 is a further schematic diagram of a scene in which the cleaning robot performs an outer edge exploration to a preset ground material according to an embodiment of the present disclosure.

As shown in FIG. 6, the cleaning robot 1 performs outer edge exploration on the area 2 of the preset ground material by way of the right-edge exploration, the position 20 corresponds the first contour point, at position 21, an obstacle is encountered by the cleaning robot 1 for the first time, at that time, the cleaning robot 1 is controlled to turn around in place to continue the outer edge exploration task along the left-edge exploration direction opposite to the right-edge exploration direction, or navigate to the first contour point and then continue the outer edge exploration task along the left-edge exploration direction opposite to the right-edge exploration direction, which is not limited herein. The edge exploration is completed in case the cleaning robot 1 encounters an obstacle for the second time at position 22. In this process, the obstacles encountered by the cleaning robot 1 can be the same obstacle or different obstacles, which is not limited herein.

In some embodiments, after the obtaining the contour of the preset ground material, the method further includes:

determining the contour of the preset ground material based on information of the contour points.

It is to be understood that the contour of the preset ground material is determined by the obtained plurality of contour points of the preset ground material, and after the cleaning robot 1 obtains the contour points of the preset ground material, the plurality of contour points are fit to obtain the contour of the preset ground material.

In some embodiments, after the obtaining the contour of the preset ground material, the method further includes:
in case the edge exploration mode is the outer edge exploration mode and the contour of the preset ground material cannot be determined based on the contour points, the cleaning robot is controlled to perform edge exploration on the preset ground material based on the inner edge exploration mode to obtain the contour of the preset ground material.

It should be understood that, for example, in case the preset ground material has at least one edge close to the room wall, and the cleaning robot 1 is unable to explore the edge close to the room wall when exploring the preset ground material in the outer edge exploration mode, then too much information of the contour points detected by the cleaning robot is missing, and the contour of the preset ground material cannot be determined. As such, the integrity of the contour of the preset ground material can be improved by combining the inner edge exploration mode.

Referring to FIGS. 7-9, FIGS. 7-9 are schematic diagrams of scenes in which the cleaning robot determines the contour of a preset ground material by connecting or fitting contour points, or by executing a graphic matching process to contour points, according to embodiments of the present disclosure.

As shown in FIG. 7, after the cleaning robot 1 explores the inner edge of the area 2 in the inner edge exploration mode, a plurality of contour points are determined, and the contour of the preset ground material is obtained by connecting each of the contour points.

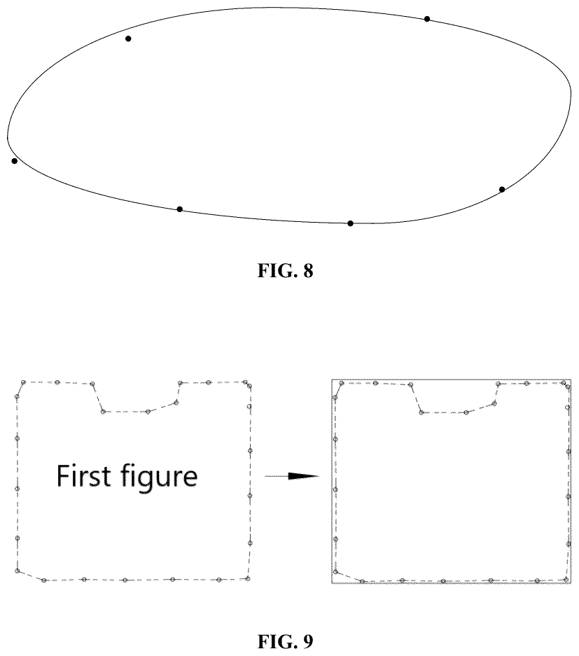

As shown in FIG. 8, after the cleaning robot 1 explores the inner edge of the material area 2 in the inner edge exploration mode, a plurality of contour points are determined, and a relatively smooth contour of the preset ground material is obtained by fitting each of the contour points.

Referring to FIG. 9, FIG. 9 is a schematic diagram of a scene for graphic matching processing the contours of a preset ground material according to an embodiment of the present disclosure.

As shown in FIG. 9, the boundary contour obtained by connecting the contour points is graphically matched to obtain a rectangular contour of the preset ground material.

It should be understood that the preset ground material is commonly a regular shape. In some embodiments, a first figure is obtained by the cleaning robot 1 after connecting the various contour points, and the contour of the preset ground material is determined by calculating the matching degree between the minimum polygon enclosing the first figure and the first figure.

Exemplarily, in case the cleaning robot 1 calculates that the matching degree between the minimum rectangle enclosing the first figure and the first figure is 98%, and the minimum trapezoid enclosing the first figure and the first figure is 60%, then the minimum rectangle is determined to be the contour of the preset ground material.

In some embodiments, after determining the contour of the preset ground material based on the contour points, the method further includes:
determining a first material area according to the contour of the preset ground material and obtaining a second material area closest to the first material area from a pre-constructed clean area map, wherein a ground material type corresponding to the first material area is the same as that of the second material area;
merging the first material area with the second material area in the clean area map, in case the distance between the first material area and the second material area is less than or equal to a preset interval distance.

It should be understood that the cleaning area map is a pre-constructed map of the cleaning robot 1 and is configured to design a travel path or a cleaning path. After determining the first material area according to the preset ground material contour, it is determined whether there is a material area with the same ground material type as the first material area based on the cleaning map, and in case there are material areas with the same ground material type as the first material area, the material area which is closest to the first material area is selected to be the second material area. The distance between two material areas may be the shortest distance or longest distance between the contour points of the two areas, which is not limited here.

The type of ground material is characterized by preset ground material type, exemplarily, in case the type of ground material in the first material area is the carpet type, then the type of ground material in the second material area is also the carpet type.

It should be understood that in case the first material area and the second material area are very close to each other, it is very likely that the first material area and the second material area belong to the same preset ground material. This may be caused by an obstacle placed in one preset ground material. After merging the first material area and the second material area, the cleaning robot may design the advance trajectory or task better, for example, the first material area and the second material area which belong to the same preset ground material are identified and merged to be regarded as a complete material area by the cleaning robot, in case the obstacle which separates the preset ground material is removed, the cleaning robot can complete the cleaning of the preset ground material based on a single cleaning plan, and the area previously occupied by the obstacle will also be cleaned together, There is no need to plan the cleaning for the first material area and the second material area separately, and there will not be the situation that the area previously occupied by the obstacle is missed from cleaning.

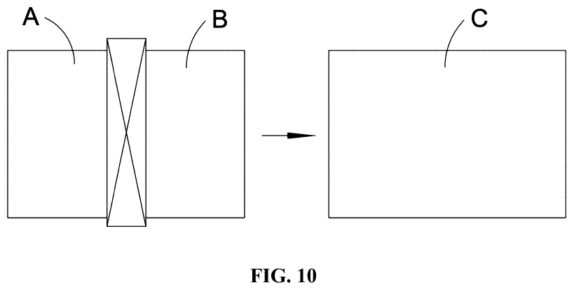

Referring to FIG. 10, FIG. 10 is a schematic diagram of a scene in which the cleaning robot merges adjacent material areas according to an embodiment of the present disclosure.

As shown in FIG. 10, A is the first material area determined by the cleaning robot 1 according to the contour of the preset ground material, B is the second material area closest to the first material area A obtained from the cleaning area map, and in case the distance between the first material area A and the second material area B is less than or equal to the preset interval distance, the first material area A and the second material area B are merged to obtain the material area C.

In some embodiments, the preset interval distance may be set to 20 cm, 30 cm, or 40 cm, in addition, the preset interval distance may also be set to other distances according to the actual needs, which is not limited herein.

In some embodiments, after determining the contour of the preset ground material based on the contour points, the method further includes:

controlling the cleaning robot to clean the preset ground material in a first boustrophedon path via the side brushing member and/or the middle brushing member, according to the contour of the preset ground material; and

controlling the cleaning robot to clean the preset ground material in a second boustrophedon path via the side brushing member and/or the middle brushing member according to the contour of the preset ground material, wherein the second boustrophedon path is orthogonal to the first boustrophedon path.

It should be understood that after determining the contour of the preset ground material, the cleaning path can be determined based on the contour of the preset ground material. As shown in FIG. 11, the cleaning robot 1 cleans the preset ground material by the side brushing member 10 during moving according to the first boustrophedon path and the second boustrophedon path.

In addition, the second boustrophedon path is orthogonal to the first boustrophedon path, then the second boustrophedon path and the first boustrophedon path form a tic-tac-toe path, so that the trajectory of the cleaning robot 1 covers all areas of the preset ground material, and incomplete sweeping and missed sweeping can be avoided. With the technical solution provided by the embodiments, the cleaning effect of the cleaning robot 1 on the preset ground material is improved.

In the present disclosure, when the preset ground material is detected by the cleaning robot, the status information of the cleaning robot is obtained and the edge exploration mode is determined based on the status information, wherein the edge exploration mode is either an inner edge exploration mode or an outer edge exploration mode. The edge exploration on the preset ground material is performed according to the edge exploration mode to obtain the contour of the preset ground material. By the technical solution provided in the disclosure, it is achieved to control the cleaning robot to explore the preset ground material when the preset ground material is detected by the cleaning robot.

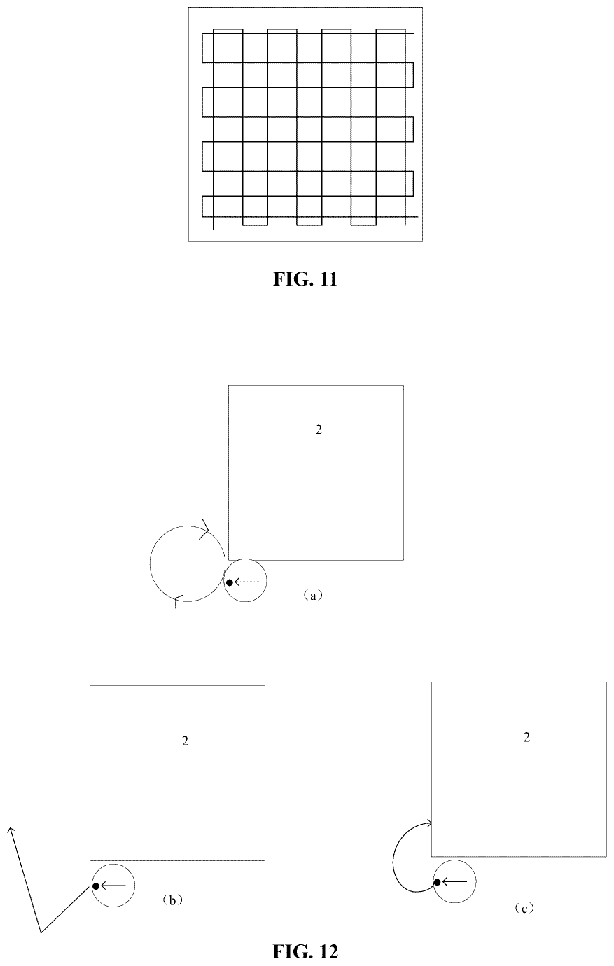

In related arts, the cleaning robot explores the ground material commonly along a zigzag path or a circular arc path, that is, the cleaning robot is controlled to rotate to a preset direction and to advance straight until the cleaning robot detects the target signal, and then the cleaning robot is controlled to rotate to another direction and to move away from the position where the target signal is detected, and so on, to repeat to form the zigzag exploring path. Or, the cleaning robot is controlled to move with constant angular velocity and linear velocity until the cleaning robot detects the target signal, and then the cleaning robot is controlled to move away from the position where the target signal is detected with constant angular velocity and linear velocity, and so on, to repeat to form the circular arc exploring path. Regardless of whether it is the zigzag exploration path or circular arc exploration mode, the exploration range is relatively limited and cannot take into account both exploration efficiency and integrity. FIG. 12 respectively shows the zigzag trajectory, circular arc trajectory, and spiral trajectory for exploring the preset ground material.

Embodiments of the present disclosure provide a method for exploring a ground material, a cleaning robot, and a storage medium. The method is applied to a cleaning robot, and the cleaning robot may be a ground sweeper, or other intelligent robots, which is not limited herein.

Some embodiments of the present disclosure are described in detail below in conjunction with the drawings. The following embodiments and features in the embodiments can be combined with each other without conflict.

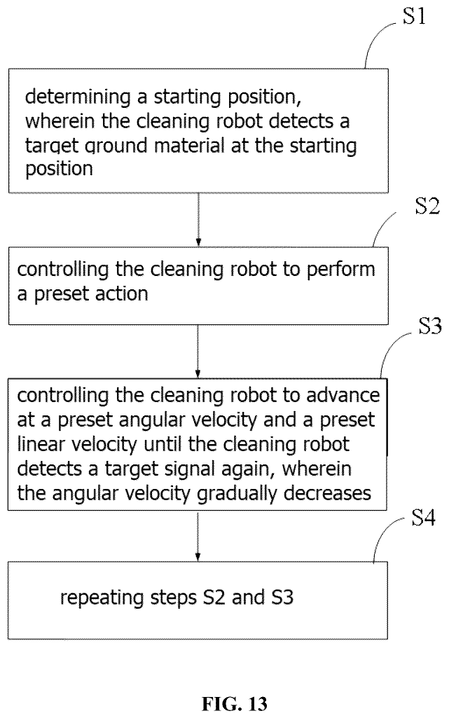

Referring to FIG. 13, FIG. 13 is a schematic flow diagram of the steps of a method for exploring a ground material according to an embodiment of the present disclosure.

As shown in FIG. 13, the method for exploring the ground material includes steps S1 to S4.

Step S1, determining a starting position, the cleaning robot detecting a target ground material at the starting position.

In some embodiments, the cleaning robot detects the preset ground material (such as carpet, foot mat, and other ground material requiring special treatment) and non-preset ground material through sensors (such as ultrasonic sensors) during traveling, and the target material can be preset ground material or non-preset ground material according to different exploration actions. For example, in case an outer edge exploration action is applied, the target material is the preset ground material; in case an inner edge exploration action is applied, the target material is the non-preset ground material. In case the outer edge exploration action is applied, the position of the cleaning robot when the cleaning robot first detects the preset ground material is taken as the starting position. In case the inner edge exploration action is applied, the position of the cleaning robot when the cleaning robot detects the non-preset ground material again during the following exploration after the cleaning robot first detects the preset ground material is taken as the starting position.

Step S2, controlling the cleaning robot to perform a preset action.

During the cleaning robot performing step S1 or S2, the method for exploring the ground material further includes: obtaining contour points of the preset ground material and marking a contour point of the preset ground material obtained for a first time as a first contour point. The first contour point position is the coordinate of the cleaning robot where the cleaning robot obtains a first one of the contour points. In case the coordinate of the cleaning robot coincides with or is at a preset distance from the coordinate of the cleaning robot at the time when the cleaning robot acquires the first one of the contour points, it can be determined that the cleaning robot has arrived at the first contour point position again. In some embodiments, the coordinate of the cleaning robot may be determined by the coordinate of the sensor that detects the ground material. The coordinate of the cleaning robot where the preset ground material is detected by the cleaning robot during executing the step S1 or S2 is determined as the contour point of the preset ground material.

In some embodiments, the cleaning robot, after determining the starting position, performs a preset action to complete a preparatory action for the edge exploration action, wherein different exploration actions correspond to different preset actions. In case the cleaning robot takes an outer edge exploration action, the cleaning robot performs the preset action in the step S2 after marking the first acquired contour point of the preset ground material as a first contour point during executing the step S1. In case the cleaning robot takes an inner edge exploration action, due to the need to determine the edge of the preset ground material and adjust the starting pose of the cleaning robot at the beginning of the exploration action, the cleaning robot marks the contour point of the preset ground material acquired the first time by the cleaning robot during performing the preset action as the first contour point during the execution of the step S2.

Step S3, controlling the cleaning robot to advance at a preset angular velocity and a preset linear velocity until the cleaning robot detects the target signal again, wherein the angular velocity gradually decreases.

In some embodiments, the cleaning robot travels at a preset angular velocity and a preset linear velocity with the angular velocity gradually decreasing until the cleaning robot detects the target signal again. The target signal may be a preset ground material signal or a non-preset ground material signal depending on the exploration action. For example, in case an outer edge exploration action is applied, the target signal is a preset ground material signal; and in case the inner edge exploration action is applied, the target signal is a non-preset ground material signal. It should be understood that controlling the cleaning robot to travel at a preset angular velocity and a preset linear velocity with the angular velocity gradually decreasing, can make the range explored by the cleaning robot be gradually expanded in a spiral shape with the cleaning robot as a center, which can ensure that the preset ground material can be detected by the cleaning robot, i.e., ensure that the contour points of the preset ground material can be detected by the cleaning robot again, so as to smoothly proceed the next exploration action for continue exploring the preset ground material. Step S4, repeating steps S2 and S3.

In some embodiments, the cleaning robot repeats the steps S2 and S3, and so on, to obtain additional contour points of the preset ground material.

In some embodiments, the method for exploring a ground material further includes: ending the exploration of the preset ground material in case determining that the cleaning robot reaches the first contour point position again. The cleaning robot, after performing the steps S1-S4, acquires a number of contour points of the preset ground material, and ends the exploration of the preset ground material in case the cleaning robot detects reaching the first contour point again. It is to be understood that in case the cleaning robot reaches the first contour point position again, it indicates that the cleaning robot returns to the position where the first contour point was detected and the exploration path of the preset ground material has formed a closed loop, i.e., the cleaning robot has completed the exploration of the preset ground material. It should be understood that the cleaning robot reaches the first contour point position again is not limited to that the cleaning robot must return to the position coinciding with the first contour point, and it can also be determined that the cleaning robot reaches the first contour point again in case the distance between the cleaning robot and the first contour point is less than a preset distance threshold.

In some embodiments, the method for exploring the ground material further includes: the target ground material being a preset ground material; the step S2 including: controlling the cleaning robot to retreat until the cleaning robot detects the non-preset ground material and continue to retreat a preset distance; or controlling the cleaning robot to rotate a preset angle in a preset direction until the cleaning robot detects the non-preset ground material; or controlling the cleaning robot to retreat until the cleaning robot detects the non-preset ground material, continue to retreat a preset distance, and then controlling the cleaning robot to rotate a preset angle in a preset direction.

It should be understood that in case the target ground material is a preset ground material and the cleaning robot takes an outer edge exploration action, step S2 may be to control the cleaning robot to retreat until the cleaning robot detects a non-preset ground material, and then continue to retreat a preset distance; step S2 may also be to control the cleaning robot to rotate in a preset direction until the cleaning robot detects the non-preset ground material; as shown in FIG. 5(d)-(e), the second preset action may also be to control the cleaning robot to retreat until the cleaning robot detects the non-preset ground material, to continue to retreat a preset distance and then to control the cleaning robot to rotate a preset angle in a preset direction. By controlling the cleaning robot to retreat a preset distance, it is possible to ensure that the mopping member of the cleaning robot is on the outer side of the preset ground material in the process of the cleaning robot traveling at a preset angular velocity and a preset linear velocity with the angular velocity gradually decreasing, which can avoid that the mopping member enters the range of the material area and wets or contaminates the preset ground material in the process of the cleaning robot traveling at a preset angular velocity and a preset linear velocity with the angular velocity gradually decreasing. Specifically, take a circular cleaning robot as an example, the preset distance of retreating is related to the longest distance of the orthogonal projection of the coverage area of the mopping member beyond the edge of the cleaning robot. And the rotation of the cleaning robot at a preset angle in a preset direction lengthens the trajectory of the cleaning robot advancing at a preset angular velocity (which is gradually decreasing) and a preset linear velocity, namely, the density of the contour points that the cleaning robot explores can be reduced, thus the efficiency of the outer edge exploration can be improved and the length of time for the cleaning robot to complete the outer edge exploration is shortened.

In some embodiments, the method for exploring the ground material further includes: in case the target ground material is a preset ground material, controlling the cleaning robot to turn around in place or navigate to the first contour point in response to the cleaning robot detecting an obstacle during the execution of steps S2 and S3; and ending the exploration of the preset ground material when the cleaning robot detects the obstacle again.

It should be understood that in case the cleaning robot takes the outer edge exploration action, the target ground material is the preset ground material, it should be understood that turning around in place and directly continuing the outer edge exploration task will repeat the exploration on part of the preset ground material that has already been explored, so it is more efficient for the cleaning robot to navigate to the first contour point and then continue the outer edge exploration task compared with the turning around in place and directly continuing the outer edge exploration task.

Referring to FIG. 6, FIG. 6 is a further schematic diagram of a scene in which the cleaning robot performs an outer edge exploration on a preset ground material according to an embodiment of the present disclosure.

As shown in FIG. 6, the cleaning robot 1 is in the process of performing outer edge exploration on the area 2 of the preset ground material along the right-edge exploration direction, the position 20 is the first contour point, and the obstacle is encountered by the cleaning robot for the first time at the position 21, at that time, the cleaning robot is controlled to turn around in place and continue the outer edge exploration task along the left-edge exploration direction opposite to the right-edge exploration direction, or navigate to the first contour point 20 and then continue the outer edge exploration task along the left-edge exploration direction opposite to the right-edge exploration direction, which is not limited herein. The edge exploration is completed in case the cleaning robot 1 encounters an obstacle for the second time at position 22. In this process, the obstacles encountered by the cleaning robot 1 can be the same obstacle or different obstacles, which is not limited herein.

In some embodiments, the method for exploring the ground material further includes: the target ground material being non-preset ground material; the step S1 including: determining that the cleaning robot detects the preset ground material for the first time; controlling the cleaning robot to rotate, obtaining in real time the rotation angle of the cleaning robot and the detection result of the cleaning robot on the ground material, determining that the detection result of the cleaning robot on the ground material is that the non-preset ground material is detected and the rotation angle of the cleaning robot obtained is smaller than 180°, controlling the cleaning robot to stop rotating; determining that the rotation angle of the cleaning robot reaches 180° and the non-preset ground material is not detected by the cleaning robot, controlling the cleaning robot to stop rotating and controlling the cleaning robot to advance straight along the current direction until the cleaning robot detects the non-preset ground material, and taking the position of the cleaning robot where the non-preset ground material is detected by the cleaning robot as the starting position.

It should be understood that in case inner edge exploration is applied and the target ground material is a non-preset ground material, since there is a certain lag in the sensor detection results, a large portion of the cleaning robot may already be on the preset ground material when the cleaning robot detects the preset ground material for the first time. In case the edge exploration mode is the inner edge exploration mode, in order to make the cleaning robot go to the edge of the preset ground material faster, the cleaning robot may be controlled to rotate and quickly determine whether the current position of the cleaning robot is close to the edge of the preset ground material. As shown in FIG. 2(a)-(b), when the non-preset ground material is detected by the cleaning robot and the rotation angle of the cleaning robot is smaller than 180°, it is determined that the current position of the cleaning robot is close to the edge of the preset ground material, at that time, the cleaning robot is controlled to stop rotating. As shown in FIG. 2(c)-(e), in case the non-preset ground material is still not detected by the cleaning robot when the rotation angle reaches 180°, it is determined that the cleaning robot has been located on the preset ground material, at which time the cleaning robot may be controlled to stop rotating and advance straight along the current direction until the cleaning robot detects the non-preset ground material, and at this time it can be determined that the current position of the cleaning robot is close to the edge of the preset ground material, then the cleaning robot may be controlled to stop advancing, to perform the next inner edge exploration behaviors.

In some embodiments, the method for exploring a ground material further includes: the target ground material being a non-preset ground material, the step S2 including: controlling the cleaning robot to rotate in a first direction until the cleaning robot detects the preset ground material.

It is to be understood that in case inner edge exploration is applied and the target ground material is a non-preset ground material, when the current position of the cleaning robot is determined to be close to the edge of the preset ground material, namely, the cleaning robot is located at the starting position, the cleaning robot is controlled to rotate in the first direction, and when the preset ground material is detected by the cleaning robot again, it is determined that the current coordinate of the cleaning robot can be marked as a first contour point. It should be understood that the first direction may be clockwise with the cleaning robot as a reference, or counterclockwise with the cleaning robot as a reference.

Embodiments of the present disclosure provide a cleaning robot including a processor, a memory, and computer-executable instructions stored in the memory and executable by the processor. When the computer-executable instructions are executed by the processor, the steps of the method for exploring the ground material described above are implemented.

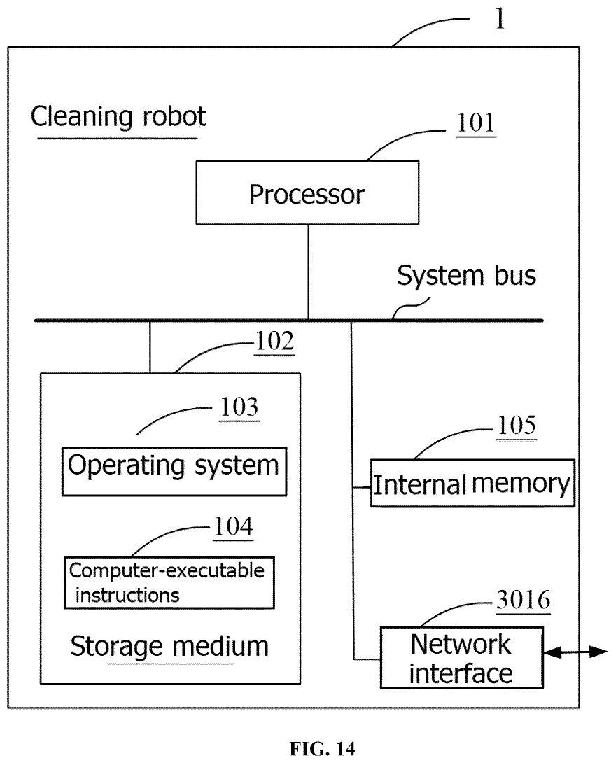

Referring to FIG. 14, FIG. 14 is a structural schematic block diagram of a cleaning robot provided by embodiments of the present disclosure. The cleaning robot includes, but is not limited to, a ground sweeper.

As shown in FIG. 14, the cleaning robot 1 includes a processor 101, a memory, and a network interface, all of which are connected via a system bus. The memory may include a storage medium 102 and an internal memory 105, and the storage medium 102 may be non-volatile or volatile.

The storage medium 102 may store operating system 103 and computer-executable instructions 104. The computer-executable instructions 104 when executed, may cause the processor 101 to perform any of the method for exploring a ground material.

The processor 101 is configured to calculate and control to support the operation of the entire cleaning robot.

The internal memory 105 provides an environment for the operation of the computer-executable instructions 104 stored in the storage medium 102. When executed by the processor 101, the computer-executable instructions 104 may cause the processor 101 to perform any of the method for exploring a ground material.

The network interface is configured for network communication, such as sending or obtaining assigned tasks, etc. It will be understood by those skilled in the art that the structure illustrated in FIG. 14 is only part of the structural block diagram of the cleaning robot that relates to the present disclosure scheme, and does not constitute a limitation of the cleaning robot to which the present disclosure scheme is applied. The cleaning robot may include more or fewer components than the cleaning robot shown in the Figure, or combine certain components, or have different arrangement of components.

It should be understood that the processor 101 may be a Central Processing Unit (CPU), which may also be other general-purpose processors, Digital Signal Processors (DSP), Application specific Integrated Circuit (ASIC), Field-Programmable Gate Array (FPGA), or other programmable logic device, discrete gate, or transistor logic device, discrete hardware component, etc. Among them, the general-purpose processor may be a microprocessor or any conventional processor, etc.

In some embodiments, the processor 101 is configured to execute the computer-executable instructions 104 stored in memory to implement the following steps:
in response to a preset ground material being detected by the cleaning robot, obtaining status information of the cleaning robot, and determining an edge exploration mode based on the status information, wherein the edge exploration mode includes an inner edge exploration mode and an outer edge exploration mode;
performing edge exploration on the preset ground material according to the edge exploration mode and obtaining a contour of the preset ground material.

In some embodiments, while the status information of the cleaning robot is obtained and an edge exploration mode is determined based on the status information, the processor 101 is configured to implement:
obtaining configuration information of the cleaning robot and selecting either one of the inner edge exploration mode and the outer edge exploration mode based on the configuration information; or
obtaining environmental information around the cleaning robot and selecting either one of the inner edge exploration mode and the outer edge exploration mode based on the environmental information.

In some embodiments, the configuration information includes the working mode of the cleaning robot and/or the status of the ground material cleaning function.

In some embodiments, while edge exploration is performed on the preset ground material according to the edge exploration mode and obtaining a contour of the preset ground material, the processor 101 is configured to implement:
in response to the preset ground material being detected by the cleaning robot, controlling the cleaning robot to perform an inner edge exploration task to obtain contour points of the preset ground material until the cleaning robot reaches a first contour point position again, wherein the first contour point position is the position where the cleaning robot obtained a first one of the contour points.

In some embodiments, while the cleaning robot is controlled to perform an inner edge exploration task to obtain contour points of the preset ground material, the processor 101 is configured to implement:
controlling the cleaning robot to perform a first preset action until the cleaning robot detects a non-preset ground material;
controlling the cleaning robot to rotate in a first direction, and obtaining the current coordinate of the cleaning robot and marking it as the contour point in response to the preset ground material being detected by the cleaning robot again;
controlling the cleaning robot to advance at a preset angular velocity and a preset linear velocity, and repeating the step of controlling the cleaning robot to rotate in the first direction to obtain the contour point in response to the non-preset ground material being detected by the cleaning robot again.

In some embodiments, while the cleaning robot is controlled to perform the first preset action until the cleaning robot detects a non-preset ground material, the processor 101 is configured to implement:
controlling the cleaning robot to rotate, obtaining in real time the rotation angle of the cleaning robot and the detection result of the cleaning robot to the ground material, determining that the detection result of the cleaning robot on the ground material is that the non-preset ground material is detected and the rotation angle of the cleaning robot obtained is determined to be smaller than 180°, controlling the cleaning robot to stop rotating; determining that the rotation angle of the cleaning robot reaches 180° and the cleaning robot does not detect the non-preset ground material, controlling the cleaning robot to stop rotating and controlling the cleaning robot to advance straight along the current direction until the cleaning robot detects the non-preset ground material.

In some embodiments, the direction of the angular velocity is determined according to the first direction.

In some embodiments, the angular velocity gradually decreases.

In some embodiments, the cleaning robot is provided with at least one of a brushing member and a mopping member, wherein the brushing member includes a side brushing member and/or a middle brushing member.

When it is determined that the cleaning robot detects the preset ground material, the method further includes at least one of the following operations:
controlling the side brushing member to be in the retracted state in case the cleaning robot is provided with the side brushing member;
controlling the middle brushing member to be in the off-ground state in case the cleaning robot is provided with the middle brushing member;
controlling the mopping member to be in an off-ground state in case the cleaning robot is provided with the mopping member.

In some embodiments, while an edge exploration is performed on the preset ground material according to the edge exploration mode to obtain a contour of the preset ground material, the processor 101 is configured to implement:
marking the current position of the cleaning robot as a first contour point position, in response to the preset ground material being detected by the cleaning robot first time;
controlling the cleaning robot to perform an outer edge exploration task to obtain contour points of the preset ground material until the cleaning robot reaches the first contour point position again.

In some embodiments, while the cleaning robot is controlled to perform an outer edge exploration task to obtain contour points of the preset ground material, the processor 101 is configured to implement:
controlling the cleaning robot to perform a second preset action, and the cleaning robot detects a non-preset ground material when the cleaning robot completes the second preset action;
controlling the cleaning robot to advance at a preset angular velocity and a preset linear velocity, and in response to the preset ground material being detected by the cleaning robot again, obtaining a current coordinate of the cleaning robot and marking the current coordinate as the contour point;
repeating the step of controlling the cleaning robot to perform the second preset action to continue obtaining the contour points.

In some embodiments, the second preset action is to control the cleaning robot to retreat until the cleaning robot detects the non-preset ground material and then continue to retreat a preset distance; or to control the cleaning robot to rotate in a preset direction until the cleaning robot detects the non-preset ground material; or to control the cleaning robot to retreat until the cleaning robot detects the non-preset ground material and continue to retreat a preset distance, and then control the cleaning robot to rotate a preset angle in a preset direction.

In some embodiments, the angular velocity decreases gradually.

In some embodiments, while an edge exploration is performed on the preset ground material according to the edge exploration mode to obtain a contour of the preset ground material, the processor 101 is configured to implement:
marking the current position of the cleaning robot as a first contour point position, in response to the preset ground material being detected by the cleaning robot first time;
controlling the cleaning robot to perform an outer edge exploration task in a second direction to obtain the contour points of the preset ground material;
controlling the cleaning robot to perform a third preset action in response to an obstacle being detected by the cleaning robot, and controlling the cleaning robot to perform the outer edge exploration task in a third direction to obtain the contour points of the preset ground material, wherein the third direction is opposite to the second direction;
ending the outer edge exploration task in response to an obstacle being detected by the cleaning robot again.

In some embodiments, the third preset action is to turn around in place; or navigate to the first contour point.

In some embodiments, the processor 101, while obtaining the contour of the preset ground material, is configured to implement:
determining the contour of the preset ground material by connecting, fitting, or graphic matching processing the contour points.

In some embodiments, the processor 101 is further configured to implement:

in case the cleaning robot performs an outer edge exploration task and the contour of the preset ground material cannot be determined based on the contour points, controlling the cleaning robot to perform an edge exploration on the preset ground material based on the inner edge exploration mode to obtain the contour of the preset ground material.

In some embodiments, after the contour of the preset ground material is determined based on the contour points, the processor 101 is further configured to implement:
determining a first material area according to the contour of the preset ground material and obtaining a second material area closest to the first material area from a pre-constructed clean area map, wherein the ground material type corresponding to the first material area is the same as the ground material type corresponding to the second material area;
merging the first material area with the second material area in the clean area map, in case the distance between the first material area and the second material area is less than or equal to a preset spacing distance.

In some embodiments, after determining the contour of the preset ground material based on information of the contour points, the processor 101 is further configured to implement:
controlling the cleaning robot to clean the preset ground material in a first boustrophedon path via the side brushing member and/or the middle brushing member according to the contour of the preset ground material;
controlling the cleaning robot to clean the preset ground material in a second boustrophedon path via the side brushing member and/or the middle brushing member according to the contour of the preset ground material, wherein the second boustrophedon path is orthogonal to the first boustrophedon path.

In some embodiments, the processor 101 is configured to execute the computer-executable instructions 104 stored in memory to implement the steps of:
Step S1: determining a starting position, and the cleaning robot detecting a target ground material at the starting position;
Step S2: controlling the cleaning robot to perform a preset action;
Step S3: controlling the cleaning robot to advance at a preset angular velocity and a preset linear velocity until the cleaning robot detects the target signal again, wherein the angular velocity gradually decreases;
Step S4: repeating steps S2 and S3;
In the process of the cleaning robot performing step S1 or S2, further including: obtaining contour points of the preset ground material and marking the first acquired contour point of the preset ground material a first contour point, wherein the contour points of the preset ground material are coordinates of the cleaning robot when the preset ground material is detected in the process of performing step S1 or S2.

In some embodiments, the processor 101 is further configured to implement:

ending the exploration of the preset ground material in case determining that the cleaning robot reaches the first contour point position again.

In some embodiments, the target ground material is a preset ground material; while the cleaning robot is controlled to perform a preset action, the processor 101 is configured to implement:
controlling the cleaning robot to retreat until the cleaning robot detects a non-preset ground material and continue to retreat a preset distance; or
controlling the cleaning robot to rotate a preset angle in a preset direction; or
controlling the cleaning robot to retreat until the cleaning robot detects the non-preset ground material and continue to retreat a preset distance, then controlling the cleaning robot to rotate a preset angle in a preset direction.

In some embodiments, the processor 101 is further configured to implement:
controlling the cleaning robot to turn around in place or navigate to the first contour point, in response to an obstacle being detected by the cleaning robot during the process of executing steps S2 and S3; and
ending the exploration of the preset ground material, in response to an obstacle being detected by the cleaning robot again.

In some embodiments, the target ground material is a non-preset ground material; when the starting position is determined and the cleaning robot detects a target ground material at the starting position, the processor 101 is configured to implement:
determining that the cleaning robot detects the preset ground material first time;
controlling the cleaning robot to rotate, obtaining in real time the rotation angle of the cleaning robot and a detection result of the cleaning robot on ground material, determining that the detection result of the cleaning robot to the ground material is that the non-preset ground material is detected and the rotation angle of the cleaning robot acquired is determined to be smaller than 180°, controlling the cleaning robot to stop rotating; determining that the rotation angle of the cleaning robot reaches 180° and the non-preset ground material is not detected by the cleaning robot, controlling the cleaning robot to stop rotating and controlling the cleaning robot to advance straight along a current direction until the cleaning robot detects the non-preset ground material, and taking the position of the cleaning robot where the non-preset ground material is detected by the cleaning robot as the starting position.

In some embodiments, while the cleaning robot is controlled to perform the preset action, the processor 101 is configured to implement:

controlling the cleaning robot to rotate in a first direction until the cleaning robot detects the preset ground material.

It should be noted that a person skilled in the field can clearly understand that, for the convenience and brevity of description, the above description of the specific working process of the cleaning robot can be referred to the corresponding process in the aforementioned method for exploring the ground material, which will not be repeated herein.

Embodiments of the present disclosure further provide a storage medium.

The storage medium is a computer readable storage medium having computer-executable instructions stored thereon. The computer-executable instructions, when being executed, implement the method that can be referred to the various embodiments of the method for exploring the ground material of the present disclosure.

The computer readable storage medium may be an internal storage unit of the cleaning robot as described in the preceding embodiment, such as a hard disk or memory of the cleaning robot. The computer readable storage medium may also be an external storage device of the cleaning robot, such as a plug-in hard drive, Smart medium Card (SMC), Secure Digital (SD) card, and Flash Card provided on the cleaning robot.

It should be understood that the terms used herein in the specification of the present disclosure are used only for the purpose of describing particular embodiments and are not intended to limit the disclosure. As used in the specification of the disclosure and the appended claims, unless the context clearly indicates, otherwise, the singular forms of “one”, “a”, and “the” are intended to include the plural form.

It is also to be understood that the term “and/or” as used in the specification and the appended claims refers to any and all possible combinations of one or more of the items listed in connection therewith, and includes such combinations. It is noted that in the disclosure, the terms “include”, “comprise”, or any other variation thereof are intended to cover non-exclusive inclusion, such that a process, method, article, or system comprising a set of elements includes not only those elements, but also other elements that are not explicitly listed, or that are inherent to such process, method, article, or system. Without further limitation, the inclusion of an element as defined by the statement “include a . . . ” does not preclude the existence of additional identical elements in the process, method, article, or system that includes that element.

The above serial numbers of the embodiments of the present disclosure are for the purpose of description only and do not represent the merits of the embodiments. The above mentioned is only a specific implementation of the present disclosure, but the scope of protection of the present disclosure is not limited thereto, and any person skilled in the art would easily conceive of various equivalent modifications or substitutions within the technical scope disclosed in the disclosure, and these modifications or substitutions should be covered within the scope of protection of the disclosure. Therefore, the protection scope of the disclosure shall be subject to the protection scope of the claims.

What is claimed is:

1. A method for exploring a ground material, applied to a cleaning robot, wherein the method comprises:
obtaining status information of the cleaning robot and selecting an edge exploration mode based on the status information when the cleaning robot detects a preset ground material, wherein the edge exploration mode is either an inner edge exploration mode or an outer edge exploration mode, the inner edge exploration mode means the cleaning robot exploring an edge of the preset ground material on an inner side of the preset ground material, and the outer edge exploration mode means the cleaning robot exploring the edge of the preset ground material on an outer side of the preset ground material; and
performing edge exploration on the preset ground material according to the edge exploration mode and obtaining a contour of the preset ground material.

2. The method as claimed in claim 1, wherein the obtaining status information of the cleaning robot and selecting an edge exploration mode based on the status information comprises:
obtaining configuration information of the cleaning robot and selecting either one of the inner edge exploration mode and the outer edge exploration mode based on the configuration information; or
obtaining environmental information around the cleaning robot and selecting either one of the inner edge exploration mode and the outer edge exploration mode based on the environmental information.

3. The method as claimed in claim 2, wherein the configuration information comprises a working mode of the cleaning robot and/or a status of a ground material cleaning function.

4. The method as claimed in claim 1, wherein in case the inner edge exploration mode is selected as the edge exploration mode, the performing edge exploration on the preset ground material according to the edge exploration mode and obtaining the contour of the preset ground material, comprises:
in response to the preset ground material being detected by the cleaning robot, controlling the cleaning robot to perform an inner edge exploration task to obtain contour points of the preset ground material until the cleaning robot reaches a first contour point position again, wherein the first contour point position is a position where the cleaning robot obtains a first one of the contour points.

5. The method as claimed in claim 4, wherein the controlling the cleaning robot to perform the inner edge exploration task to obtain contour points of the preset ground material, comprises:
controlling the cleaning robot to perform a first preset action until the cleaning robot detects a non-preset ground material;
controlling the cleaning robot to rotate in a first direction, and when the cleaning robot detects the preset ground material again, obtaining a current coordinate of the cleaning robot and marking the current coordinate as one of the contour points; and
controlling the cleaning robot to advance at a preset angular velocity and a preset linear velocity, and when the cleaning robot detects the non-preset ground material again, repeating a step of controlling the cleaning robot to rotate in the first direction to obtain the contour points.

6. The method as claimed in claim 5, wherein
the controlling the cleaning robot to perform the first preset action until the cleaning robot detects the non-preset ground material, comprises: controlling the cleaning robot to rotate, obtaining in real time a rotation angle of the cleaning robot and a detection result of the cleaning robot on a ground material; determining that the detection result of the cleaning robot on the ground material is that the non-preset ground material is detected and the rotation angle of the cleaning robot obtained is smaller than 180°, controlling the cleaning robot to stop rotating; determining that the rotation angle of the cleaning robot reaches 180° and the non-preset ground material is not detected by the cleaning robot, controlling the cleaning robot to stop rotating and controlling the cleaning robot to advance straight along a current direction until the cleaning robot detects the non-preset ground material;
and/or
a direction of the preset angular velocity is determined according to the first direction, wherein: in case the first direction is clockwise with the cleaning robot as a reference object, the direction of the preset angular velocity is perpendicular to the ground and outward; and in case the first direction is counterclockwise with the cleaning robot as a reference object, the direction of the preset angular velocity is perpendicular to the ground and inward;
and/or
the angular velocity gradually decreases.

7. The method as claimed in claim 4, wherein
the cleaning robot is provided with at least one of a brushing member and a mopping member, wherein the brushing member comprises a side brushing member and/or a middle brushing member;
determining that the preset ground material is detected by the cleaning robot, the method further comprises at least one of the following operations:
controlling the side brushing member to be in a retracted state in case the cleaning robot is provided with the side brushing member;
controlling the middle brushing member to be in an off-ground state in case the cleaning robot is provided with the middle brushing member; and
controlling the mopping member to be in an off-ground state in case the cleaning robot is provided with the mopping member;
and/or
the obtaining the contour of the preset ground material, comprises: determining the contour of the preset ground material by connecting, fitting, or graphic matching processing the contour points;
and/or
the method further comprises: when the cleaning robot performs an outer edge exploration task and the contour of the preset ground material cannot be determined based on the contour points, controlling the cleaning robot to perform an edge exploration of the preset ground material based on the inner edge exploration mode to obtain the contour of the preset ground material.

8. The method as claimed in claim 1, wherein in case the outer edge exploration mode is selected as the edge exploration mode, the performing edge exploration on the preset ground material according to the edge exploration mode and obtaining the contour of the preset ground material, comprises:
marking a current position of the cleaning robot as a first contour point position when the cleaning robot detects the preset ground material for a first time; and
controlling the cleaning robot to perform an outer edge exploration task to obtain contour points of the preset ground material until the cleaning robot reaches the first contour point position again.

9. The method as claimed in claim 8, wherein the controlling the cleaning robot to perform the outer edge exploration task to obtain contour points of the preset ground material, comprises:
controlling the cleaning robot to perform a second preset action, wherein the cleaning robot detects a non-preset ground material when the cleaning robot completes the second preset action;
controlling the cleaning robot to advance at a preset angular velocity and a preset linear velocity, and when the cleaning robot detects the preset ground material again, obtaining a current coordinate of the cleaning robot and marking the current coordinate as one of the contour points; and
repeating a step of controlling the cleaning robot to perform the second preset action to continue obtaining the contour points.

10. The method as claimed in claim 9, wherein
the second preset action is to control the cleaning robot to retreat until the cleaning robot detects the non-preset ground material and then continue to retreat a preset distance; or to control the cleaning robot to rotate in a preset direction until the cleaning robot detects the non-preset ground material; or to control the cleaning robot to retreat until the cleaning robot detects the non-preset ground material and continue to retreat a preset distance, and then control the cleaning robot to rotate a preset angle in a preset direction;
and/or
the angular velocity gradually decreases.

11. The method as claimed in claim 1, wherein in case the outer edge exploration mode is selected as the edge exploration mode, the performing edge exploration on the preset ground material according to the edge exploration mode and obtaining the contour of the preset ground material, comprises:
marking a current position of the cleaning robot as a first contour point position when the cleaning robot detects the preset ground material for a first time;
controlling the cleaning robot to perform an outer edge exploration task in a second direction to obtain contour points of the preset ground material;
controlling the cleaning robot to perform a third preset action when the cleaning robot detects an obstacle, and controlling the cleaning robot to perform the outer edge exploration task in a third direction to obtain contour points of the preset ground material, wherein the third direction is opposite to the second direction; and
ending the outer edge exploration task when the cleaning robot detects the obstacle again.

12. The method as claimed in claim 11, wherein the third preset action is to turn around in place; or to navigate to the first contour point.

13. The method as claimed in claim 1, wherein
after obtaining the contour of the preset ground material, the method further comprises:
determining a first material area according to the contour of the preset ground material and obtaining a second material area closest to the first material area from a pre-constructed clean area map, wherein a ground material type corresponding to the first material area is the same as a ground material type corresponding to the second material area; and merging the first material area with the second material area in the clean area map when a distance between the first material area and the second material area is less than or equal to a preset spacing distance;
and/or
the cleaning robot is provided with at least one of a brushing member and a mopping member, and the brushing member comprises a side brushing member and/or a middle brushing member; and after obtaining the contour of the preset ground material, the method further comprises:
controlling the cleaning robot to clean the preset ground material in a first boustrophedon path via the side brushing member and/or the middle brushing member according to the contour of the preset ground material; and controlling the cleaning robot to clean the preset ground material in a second boustrophedon path via the side brushing member and/or the middle brushing member according to the contour of the preset ground material, wherein the second boustrophedon path is orthogonal to the first boustrophedon path.

14. The method as claimed in claim 1, wherein the method comprises:
step S1: determining a starting position, wherein the cleaning robot detects a target ground material at the starting position;
step S2: controlling the cleaning robot to perform a preset action;
step S3: controlling the cleaning robot to advance at a preset angular velocity and a preset linear velocity until the cleaning robot detects a target signal again, wherein the angular velocity gradually decreases;
step S4: repeating steps S2 and S3; and
in a process of the cleaning robot performing step S1 or S2, the method further comprising: obtaining contour points of the preset ground material and marking a contour point of the preset ground material obtained for a first time as a first contour point, wherein the contour points of the preset ground material are coordinates of the cleaning robot when a preset ground material is detected in a process of performing step S1 or S2.

15. The method as claimed in claim 14, wherein the method further comprises: ending an exploration of the preset ground material in case determining that the cleaning robot reaches the first contour point position again.

16. The method as claimed in claim 14, wherein the target ground material is a preset ground material; and the step S2 comprises:
controlling the cleaning robot to retreat until the cleaning robot detects a non-preset ground material and continue to retreat a preset distance; or
controlling the cleaning robot to rotate a preset angle in a preset direction; or
controlling the cleaning robot to rotate a preset angle in a preset direction, after controlling the cleaning robot to retreat until the cleaning robot detects the non-preset ground material and continue to retreat a preset distance.

17. The method as claimed in claim 16, wherein the method further comprises:
controlling the cleaning robot to turn around in place or navigate to the first contour point when the cleaning robot detects an obstacle in a process of the cleaning robot performing steps S2 and S3; and
ending an exploration of the preset ground material when the cleaning robot detects the obstacle again.

18. The method as claimed in claim 14, wherein the target ground material is a non-preset ground material; and the step S1 comprises:
determining that the cleaning robot detects the preset ground material for a first time;
controlling the cleaning robot to rotate, obtaining in real time a rotation angle of the cleaning robot and a detection result of the cleaning robot on a ground material; determining that the detection result of the cleaning robot on the ground material is that the non-preset ground material is detected and the rotation angle of the cleaning robot obtained is smaller than 180°, controlling the cleaning robot to stop rotating; determining that the rotation angle of the cleaning robot reaches 180° and the non-preset ground material is not detected by the cleaning robot, controlling the cleaning robot to stop rotating and controlling the cleaning robot to advance straight along a current direction until the cleaning robot detects the non-preset ground material, and taking a position of the cleaning robot where the non-preset ground material is detected by the cleaning robot as the starting position.

19. A cleaning robot, wherein the cleaning robot comprises a processor, a memory, and computer-executable instructions stored on the memory and executable by the processor, wherein when the computer-executable instructions are executed by the processor, the steps of the method for exploring the ground material as claimed in claim 1 is implemented.

20. A computer readable storage medium, wherein the computer readable storage medium stores computer-executable instructions, and the computer-executable instructions, when being executed by a processor, cause the processor to implement the method for exploring the ground material as claimed in claim 1.
